(19) United States
(12) Patent Application Publication
(10) Pub. No.: US 2026/0119628 A1
(43) Pub. Date: Apr. 30, 2026

(54) ELECTRONIC DEVICES WITH A STATIC ARTIFICIAL INTELLIGENCE MODEL FOR CONTEXTUAL SITUATIONS, INCLUDING AGE BLOCKING FOR VAPING AND IGNITION START, USING DATA ANALYSIS AND OPERATING METHODS THEREOF

(71) Applicant: Aerendir Mobile Inc., Mountain View, CA (US)

(72) Inventors: Martin Zizi, Mountain View, CA (US); Luke Stork, Mountain View, CA (US); Kitae Lee, Moutain View, CA (US)

(73) Assignee: Aerendir Mobile Inc., Mountain View, CA (US)

(21) Appl. No.: 18/173,051

(22) PCT Filed: Aug. 28, 2021
(86) PCT No.: PCT/US2021/048120

§ 371 Date: Mar. 4, 2023

Related U.S. Application Data
(60) Provisional application No. 63/072,099, filed on Aug. 29, 2020.
(60) Provisional application No. 63/138,519, filed on Jan. 17, 2021.

(51) Int. Cl. G06F 21/32; G06F 3/01; G06F 21/31

(52) U.S. Cl. CPC G06F 21/32; G06F 3/011; G06F 21/316

(57) ABSTRACT

In accordance with one embodiment, a method for generating results reflecting one or more physiological conditions of a user is disclosed. The method includes generating a plurality of constrained data sets associated with a plurality of predetermined constraints linked to a plurality of predetermined physiological conditions; building a plurality of independent static models based on a plurality of predetermined physiological conditions, wherein each independent static model is linked to a specific constraint; installing the plurality of independent static models into a device including a processor to execute instructions and a sensor to collect sensor data linked to the plurality of independent static models; executing, by a user, one or more of the plurality of independent static models via a user interface based on the sensor data sensed from the user; and providing one or more results (inferences) to the user via the user interface associated with the execution of the one or more of the plurality of independent static models, wherein the one or more results reflects one or more physiological conditions of the user.

### RELATED APPLICATIONS

This patent application is a national phase filing claiming the benefit of Patent Cooperation Treaty (PCT) Application No. PCT/US2021/048120 titled ELECTRONIC DEVICES WITH A STATIC ARTIFICIAL INTELLIGENCE MODEL FOR CONTEXTUAL SITUATIONS, INCLUDING AGE BLOCKING FOR VAPING AND IGNITION START, USING DATA ANALYSIS AND OPERATING METHODS THEREOF filed on 28 Aug. 2021 by inventors Martin Zizi et al. PCT Application No. PCT/US2021/048120 claims the benefit of U.S. Provisional Patent Application No. 63/138,519 titled ELECTRONIC DEVICES WITH AN ARTIFICIAL INTELLIGENCE STATIC MODEL FOR CONTEXTUAL SITUATIONS, INCLUDING AGE BLOCKING FOR VAPING AND IGNITION START, USING DATA ANALYSIS AND METHODS FOR OPERATION OF SAME filed on 17 Jan. 2021 by inventors Martin Zizi et al.; and also claims the benefit of U.S. Provisional Patent Application No. 63/072,099 titled “ELECTRONIC DEVICES WITH AN ARTIFICIAL INTELLIGENCE STATIC MODEL FOR CONTEXTUAL SITUATIONS USING DATA ANALYSIS AND METHODS FOR OPERATION OF SAME” filed on 29 Aug. 2020 by inventors Martin Zizi et al.; both of which are incorporated herein by reference.

### FIELD

The disclosure generally relates to a static artificial intelligence (AI) model for contextual situations using data analysis.

### BRIEF DESCRIPTION OF THE DRAWINGS

FIG. 1 is a classification chart of biometric modalities.

FIG. 2 is a block diagram of overall flow processing of situational static models for artificial intelligence.

FIG. 3 is a table of examples of various types of motion classifications in body parts of a human being.

FIG. 4 is a block diagram illustrating the operating environment (a system) of electronic devices incorporating situational static models for artificial intelligence.

FIG. 5 is a more detailed block diagram of an electronic device used in the system shown in FIG. 4.

FIG. 6 is a functional block diagram of a feature processing system.

FIG. 7 is a flow chart of static model operation to provide artificial intelligence.

FIG. 8 is a functional bloc diagram of a Static Model processing system.

FIG. 9 is an example sensing structure (4^{th} dimension sensing stretching material) for the situational static model to provide artificial intelligence.

FIG. 10 is a functional block diagram of a sensor for the situational static model to provide artificial intelligence.

FIG. 11 is a plot of an acceleration waveform of a sensed acceleration signal from a body part for a single axis (X, Y, or Z) over time.

FIG. 12 is a flow chart for collecting movement signal data by an Input Data Handler of an electronic device.

FIG. 13 is a flow chart for a sleep mode operation of an electronic device with the situational static model to provide artificial intelligence with low power consumption.

FIG. 14 is a flow chart of secure mode operation of an electronic device with the situational static model to provide secure data analysis with a secure core of a multiprocessor.

FIG. 15 is a Block Diagram of the Contextual Situations Feature Extractor

FIG. 16 is a chart of various types/format of sensor data over time that may be used with the situational static model.

FIG. 17 is a flow chart of a preprocessing operation for the Contextual Situations Feature Extractor of FIG. 15.

FIG. 18 is a plot of data samples for a single axis Accelerometer over a time series.

FIG. 19 is a flow chart of feature extracting operation for generating a feature vector set.

FIG. 20 is an example table representing a feature vector set for various feature vectors providing a time series analysis over time.

FIG. 21 is a table indicating various features vectors that may be used to obtain a feature vector set for a number of different physiological states.

FIG. 22 is a chart of plots to show divergence Feature Distribution to recognize a non-human (e.g., a bot, an animal) signal distinguished from human signals.

FIG. 23A is a chart of a first plot of a time series of signal data for entropy feature analysis.

FIG. 23B is a chart of a second plot of a time series of signal data for entropy feature analysis with FIG. 23A.

FIG. 24 is a chart of a pair of gyroscope X-axis data plots of a low mean band and a high mean band of body motion data to determine blood glucose level for a blood glucose context for the static model of artificial intelligence.

FIG. 25 is a table of data sets that may be used to detect various physiological states of a human user with the static model of artificial intelligence.

FIG. 26 is a table of data sets that may be used to detect various physical characteristic of a human user with the static model of artificial intelligence.

FIG. 27 is a functional block diagram of a static model analyzer shown in FIG. 8.

FIG. 28 is a flow chart of training mode operation for the static model analyzer to obtain a time series of data of a data set.

FIG. 29 is a flow chart of an operational (inference) mode of the static AI model associated with last steps shown in FIG. 7.

FIG. 30 is a functional block diagram of a static AI model framework for a software implementation of the static AI model.

FIG. 31 is diagram showing various device types in which the static AI model may be used, including software, field programmable gate array FPGA, and a customized application specific integrated circuit (ASIC).

FIG. 32 is a static model processing system of an electronic device that can be used to detect various states of a contextual situation, such as a physiological state of liveliness, age, or gender.

FIG. 33 is a flow diagram between client (e.g., smart phone) and server for creating a new user account, associated with the server, using liveliness physiological states determined by a static AI model.

FIG. 34 is a flow diagram between client (e.g., smart phone) and server for accessing personal health records from the server using liveliness physiological states determined by a static AI model in conjunction with other authentication parameters.

FIG. 35A illustrates a flow chart of using static artificial intelligence models to pass/fail implementation of age-blocking (parental control).

FIG. 35B illustrates a client server implementation of the age blocking and processes in each.

FIG. 36 illustrates a flow chart of age based application of artificial intelligence based on neurological information to control vehicle ignition or starting.

FIG. 37 is a flow chart illustrating additional AI to provide side-effects protection from Nicotine abuse.

FIG. 38A is a diagram of the implementation forms that AI technology based on neurology can be embedded in phones, or any hardware (HW)/software (SW) system on chip (SOC) device to form a parental control device.

FIG. 38B illustrates a vaporizer with a system on a chip and the artificial intelligence to provide age blocking.

FIG. 39 illustrates plot of a 3-D vector space of three different features extracted from neural-tagging data.

### DETAILED DESCRIPTION

In the following detailed description of the embodiments of the disclosure, numerous specific details and various examples are set forth in order to provide a thorough understanding. However, it will be clear and apparent to a person having ordinary skill in the art that the embodiments may be practiced without these specific details and numerous changes or modifications of the embodiments may also be carried out within the scope of the disclosure. In certain instances, well-known methods, procedures, components, function, circuits and well known or conventional details have not been described in detail so as not to unnecessarily obscure aspects of the embodiments of the disclosure.

The terms, words and expressions used herein are merely for the purpose of describing embodiments of the disclosure and are not intended to be limiting the scope of the disclosure. Unless defined otherwise, all terms including technical and scientific terms, as used herein, may have the same or similar meanings in the context that can be understood generally by a person having ordinary skill in the art. In some instances, even though the terms are defined in the disclosure, it may not be construed to exclude or limit the scope of embodiments of the disclosure.

Embodiments in accordance with the disclosure may be implemented as an apparatus, method, server-client apparatus and/or method, cooperation of apparatus and/or method, chipset, computer program or any combination thereof. Accordingly, the embodiments may take the form of an entirely hardware embodiment (including chipset), an entirely software embodiment (including firmware, any type of software, etc.) or an embodiment combining software and hardware. Software and hardware aspects that may all generally be referred to herein as a “module”, “unit”, “component”, “block”, “element”, “member”, “system”, “subsystem” or etc. Furthermore, the embodiments may take the form of a computer program product embodied in any tangible medium of expression (including a computer file) having computer-usable program code embodied in the medium.

It can be understood that the terms “one embodiment”, “an embodiment”, “one example” or “an example” may mean that a particular feature, structure or characteristic described in connection with the embodiment or example of the disclosure. Thus, the appearances of these terms used herein are not necessarily all referring to the same embodiment or example. In addition, a particular feature, structure or characteristic may be combined in any suitable combinations and/or sub-combinations in one or more embodiments or examples.

It can be understood that the singular forms “a”, “an” or “the” may include plural forms as well unless the context clearly indicates otherwise. For example, “a sensor” may refer to one or more sensors.

It can be understood that, although the terms “first”, “second” or etc. are, in some instances, used herein to describe various elements, these elements do not be limited by these terms. These terms may be used to distinguish one element from another and may be irrelevant to the order or importance of elements. For example, a first sensor could be termed a second sensor, and, similarly, a second sensor could be termed a first sensor. The first sensor and the second sensor are both sensors, but they may not be the same sensor.

It can be understood that the term “and/or” as used herein may cover any and all possible combinations of one or more of the associated listed items. For example, “A or B”, “at least one of A and B”, “at least one of A or B”, “one or more of A or B”, “one or more of A and B”, “A and/or B”, “at least one of A and/or B”, or “one or more of A and/or B” may represent all of “including at least one A”, “including at least one B”, or “including both at least one A and at least one B”.

It can be understood that the terms “have”, “having”, “may have”, “include”, “including”, “may include”, “comprise”, “comprising” or “may comprise”, or “comprising”, used herein indicate the presence of elements, features, steps, operations, functions, numeric values, or components, members or combination thereof but do not exclude the presence or addition of one or more other elements, features, steps, operations, functions, numeric values, or components, members or combination thereof. For example, a method or apparatus that comprises a list of elements may not be necessarily limited to comprise only those elements but may include other elements that are not explicitly listed.

It can be understood that when a first element is “connected to”, “coupled to” or “coupled with” a second element, the first element may be directly “connected to”, directly “coupled to” or directly “coupled with” the second element or at least one or more of other elements may be interposed between the first element and the second element. On the other hand, it can be understood that when a first element is “directly connected” or “directly coupled” to a second element, another element is not interposed between the first element and the second element.

In the disclosure, embodiments of various types of electronic devices and associated operations related to user identification, authentication and data encryption are described. When an electronic device can acquire information about the user's contextual situations, there could be various useful types of applications that can be developed. Information regarding the user's contextual situations can also be collected from various sources. The sources may include but not limited to sensor data, user data on the internet, data set, and so on. One of the possible applications based on situational awareness can be about data analysis of the signals from the human body by AI technology. The human body is one of the well-known complex system composed of many components which may interact with each other. It has inherent rich and near infinite variations both at the molecular and at the functional levels, but it also dense and rich with information in its broadest sense. Nearly any human contextual situations (e.g., physiological state) can also be observed through complicated interaction between various organs of the human body. When it comes to a neuro-muscular tone that is affected by these contextual situations (e.g., physiological states), some type of these states coming from the human body can be well interpreted by appropriately analyzing the neuro-muscular tone signals that are collected by various types of sensors from the body part of users. When these results can be used in electronic devices, a lot of useful applications can be possible, for example, providing visual information to users about their physiological state, improving the function of current biometric applications, securing personal information with more high-security levels, or answering simple binary questions like gender, age and so on.

In some embodiments, the electronic device may be a hand held type of portable device, a smart phone, a tablet computer, a mobile phone, a telephone, an e-book reader, navigation device, a desktop computer, a laptop computer, a workstation computer, a server computer, a single board computer, a camera, a camcorder, an electronic pen, wireless communication equipment, access point (AP), a drone, a projector, an electronic board, a photo copy machine, a watch, a glasses, a head-mounted device, a wireless headset/earphone, an electronic clothing, various type of wearable devices, a television, a DVD player, an audio player, a digital multimedia player, an electronic photo frame, a set top box, a TV box, a game player, remote controller, bank ATM, payment system device (including POS, card reader), a refrigerator, an oven, a microwave oven, an air conditioner, a vacuum cleaner, a washing machine, a dishwasher, an air cleaner, a home automation control device, a smart home device, various type of home appliances, a security control device, an electronic lock/unlock device (including door key or door lock), electronic signature receiving device, various type of security system devices, a blood pressure measuring device, a blood glucose monitoring device, a heart rate monitoring device, a body temperature measuring device, a Magnetic Resonance Imaging device, a Computed Tomography device, a Magnetic Resonance Angiography device, various portable medical measuring devices, various type of medical devices, a water meter, an electric meter, a gas meter, a radio wave meter, thermostat, various kinds of measuring devices, AI device, AI speaker, AI robot, various type of IoT devices or the like.

The electronic device may be a combination or a part of one or more of the aforementioned devices. In some embodiments, the electronic device may be a part of furniture, building, structure or machine (including vehicle, car, airplane or ship) or a type of an embedded board, a chipset, computer files or some type of sensors. The electronic device of the disclosure is not limited to the aforementioned devices and may be a new form of an electronic device as technology development advances.

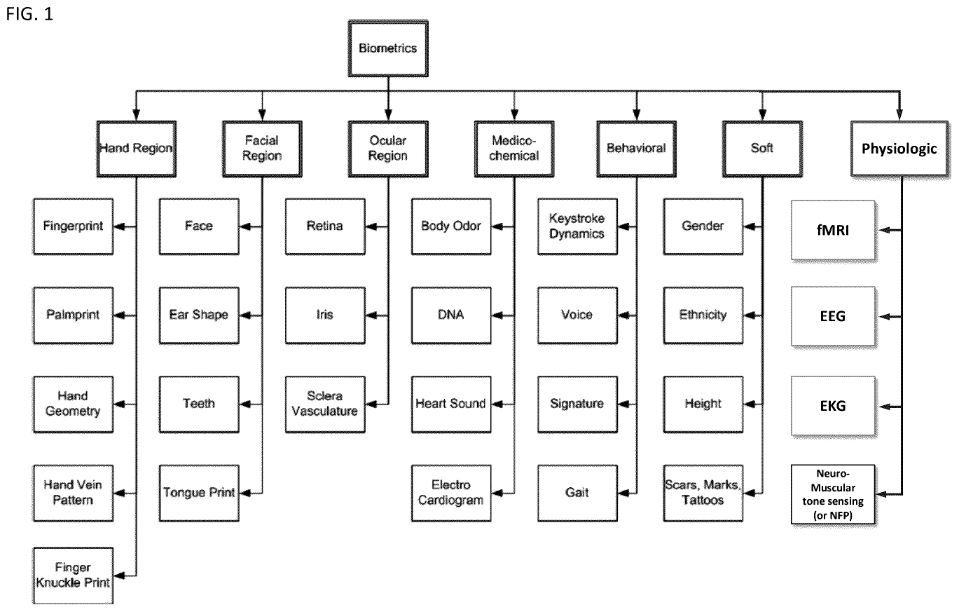

FIG. 1 shows classification of biometric modalities that is adapted from “UNAR JA, SENG W C, ABBASI A. A review of biometric technology along with trends and prospects. Pattern Recognition, 2014, 47 (8): 2673-2688”. Measurements and calculations related to human characteristics are often termed as “biometrics”. Although there can be various applications and several advantages using these traditional methods when biometrics is used in the physiological state application, known biometrics is unlikely to offer a highly robust security solution in some aspects. A physiological biometric solution disclosed herein using the AI static model for contextual situations (e.g., physiological states) of the human body related to neuro-muscular tone sensing can offer better improved, effective, solid, and heightened solutions for the physiological state applications including liveliness, identification, authentication, or encryption, or the like. The position of the neuro-muscular tone sensing technology relative to the rest of biometrics is also illustrated in FIG. 1. Contrary to the rest of the field, the neuro-muscular tone sensing technology is a live physiologic signal, being never the same and yet allowing on to be recognized.

It stands in a novel category, together with a functional MRI scan of the brain, the EEG (Electroencephalography), the ECG (Electrocardiogram), the EMG (Electromyography), the EKG (Electrocardiogram) from the heartbeats or external/internal electrode.

Behavioral biometric methods are linked to what the user does or his/her habits. Known anatomical biometric methods are linked to physical features of the user, such as fingerprints, iris eye scans, veins, facial scans, and DNA. Certain user motions are habitual or part of a user's motion repertoire. A user signing a document, for example, is a contextual motion that a user develops with behavioral habits. The motions usually analyzed of a signed signature are the macro-motions or large-scale motions that a user makes with a writing instrument. Most of these actions are voluntary movements because they are motions according to the consciousness or intention of the user. For example, from the large motions of a signed signature one may determine with one's eyes whether the writer was left-handed or right-handed.

While these large motions may be useful, there are also micro-motions (very small motions) that a user makes when signing, making other motions, or simply at rest making no motion. These micro-motions can contain neuro-derived, neuro-based, or neuro-muscular tone and it is invisible to the eyes. Therefore, it belongs to involuntary movement rather than consciousness or intention of the user. These micro-motions of a user are due to the unique neuro-muscular anatomy of each human being and may also include very important signals referred to herein as neuro-derived micro-motions or neuro-muscular tone. These signals of micro-motions are also linked to the motor control processes from the motor cortex of an individual down to his/her hands. With one or more sensors, signal processing algorithms, and/or filters, electronic signals (“motion signals” and “micro-motions signals”) can be captured that include the neuro-derived micro-motions of a user. Of specific interest are micro-motion electronic signals that represent the micro-motions of the user within the motion signals.

Therefore, when motion signals are analyzed appropriately for micro-motion signals representing micro-motions of users, the resulting data can yield stable physiological states of the users representing liveliness, blood glucose levels, stress hormone levels, presence of drugs, identifiers and so on. When the physiological states are interpreted or treated as unwritten signatures, these physiological states for unique identifiers derived from the user's neuro-muscular tones are a user's neuro-mechanical fingerprints. Neuro-mechanical fingerprints may also be referred to herein as Neuro-Fingerprint (NFP) or Neuro-Print (NP).

Micro-motions of a user are linked to the cortical and subcortical control of the motor activities in the brain or elsewhere in the nervous system of a human body. Like a mechanical filter, the specific musculoskeletal anatomy of an individual can affect the micro-motions of a user and contribute to the motion signals that include the micro-motions of a user. The signal thus contributed is a signal of movement of the muscles by the nerve signal, which can be called neuro-muscular tone. The motion signals captured from a user can also reflect part of the proprioceptive control loops that include the brain and proprioceptors that are present in a user's human body. By focusing on micro-motion signals and not macro-motion signals, an electronic device may be used with a neurological algorithm to better emulate a human cognitive interface in a machine. This can improve man-machine interfaces. For example, consider a human cognitive interface between a husband and wife or closely-knit persons. When a husband touches his wife on the arm, the wife can often times recognize that it is her husband touching her just from the feel of that touch, because she is familiar with his touch. If the touch feels unique, a human can often recognize what it is that is touching him/her just from that unique feel.

The neuro-muscular tone signals are extracted in response to micro-motions that are related to a type or form of tremor. A tremor is an unintentional, rhythmic muscle movement that causes an oscillation in one or more parts of a human body. Tremors may be visible or invisible to the unaided eye. Visible tremors are more common in middle aged and older persons. Visible tremors are sometimes considered to be a disorder in a part of the brain that controls one or more muscles throughout the body, or in particular areas, such as the hands and/or fingers.

Most tremors occur in the hands. Thus, a tremor with micro-motions can be sensed when holding a device with an accelerometer or through a finger touching a touchpad sensor.

There are different types of tremors. The most common form or type of tremor occurs in healthy individuals. Much of the time, a healthy individual does not notice this type of tremor because the motion is so small and may occur when performing other motions. The micro-motions of interest that are related to a type of tremor are so small that they are not visible to the unaided eye.

A tremor may be activated under various conditions (resting, postural, kinetic) and can be often classified as a resting tremor, an action tremor, a postural tremor, or a kinetic or intention tremor. A resting tremor is one that occurs when the affected body part is not active but is supported against gravity. An action tremor is one that is due to voluntary muscle activation, and includes numerous tremor types including a postural tremor, a kinetic or intention tremor, and a task-specific tremor. A postural tremor is linked to support the body part against gravity (like extending an arm away from the body). A kinetic or intention tremor is linked to both goal-directed and non-goal-directed movements. An example of a kinetic tremor is the motion of a moving a finger to one's nose, often used for detecting a driver for driving under the influence of alcohol. Another example of a kinetic tremor is the motion of lifting a glass of water from a table. A task-specific tremor occurs during very specific motions such as when writing on paper with a pen or pencil.

Tremors, whether visible or not to the eyes, are thought to originate in some pool of oscillating neurons within the nervous system, some brain structures, some sensory reflex mechanisms, and/or some neuro-mechanical couplings and resonances.

While numerous tremors have been described as either physiologic (without any disease) or pathological, it is accepted that the amplitudes of tremors may not be very useful in their classification. However, the frequencies of tremors and other types of invariant features associated with involuntary signals including neuro-muscular tone obtained from the user can be of interest. The frequencies of tremors and other types of invariant features allow them to be used in a useful manner to extract a signal of interest.

Numerous pathological conditions like Parkinson (3-7 Hz), cerebellar diseases (3-5 Hz), dystonias (4-7 Hz), various neuropathies (4-7 Hz) contribute motions/signals to the lower frequencies, such as frequencies at 7 Hertz (Hz) and below. Because pathological conditions are not common to all users, these frequencies of motions/signals are not useful for extracting neuro-muscular tone signals and are desirable to filter out. However, some of the embodiments disclosed herein are used to specifically focus on those pathological signals as a way to record, monitor, follow said pathologies to determine health wellness or degradation.

Other tremors, such as physiological, essential, orthostatic, and enhanced physiological tremors can occur under normal health conditions. These tremors are not pathologies per se. Accordingly, they are often present in the population as a whole. Physiological tremors, as well as others that are common to all users, are of interest because they generate micro-motions at frequencies over a range between 3 to 30 Hz, or 4 to 30 Hz. They may be activated when muscles are used to support body parts against the force of gravity. Accordingly, holding an electronic device in one's hand to support the hand and arm against gravity can generate physiological tremors that can be sensed by an accelerometer. Touching a touchpad of an electronic device with the finger of a hand and supporting it against gravity, can generate physiological tremors that can be readily sensed by a finger touchpad sensor.

Essential tremors of a kinetic type, may occur and be sensed when a user has to enter a PIN or login ID to gain access to a device or a phone. The frequency range of essential tremors can be between 4 to 12 Hz that could be reduced to a frequency range of 8 to 12 Hz to avoid sensing for tremors that are due to uncommon pathological conditions.

For the physiological tremor (or the enhanced physiological tremor, idem with larger amplitudes), the coherence of different body sides is low. That is, a physiological tremor on the left body side is not very coherent to a physiological tremor on the right body side. Accordingly, it is expected that tremors in the left hand or finger will differ from tremors in the right hand or right finger of a user. Accordingly, the AI Static Model system for contextual situations (e.g., physiological states) will require a user to be consistent in using the same side hand or finger for authentication; or alternatively, multiple authorized user calibration parameter sets, one for each hand or one for each finger that will be used to extract neuro-muscular tone signals.

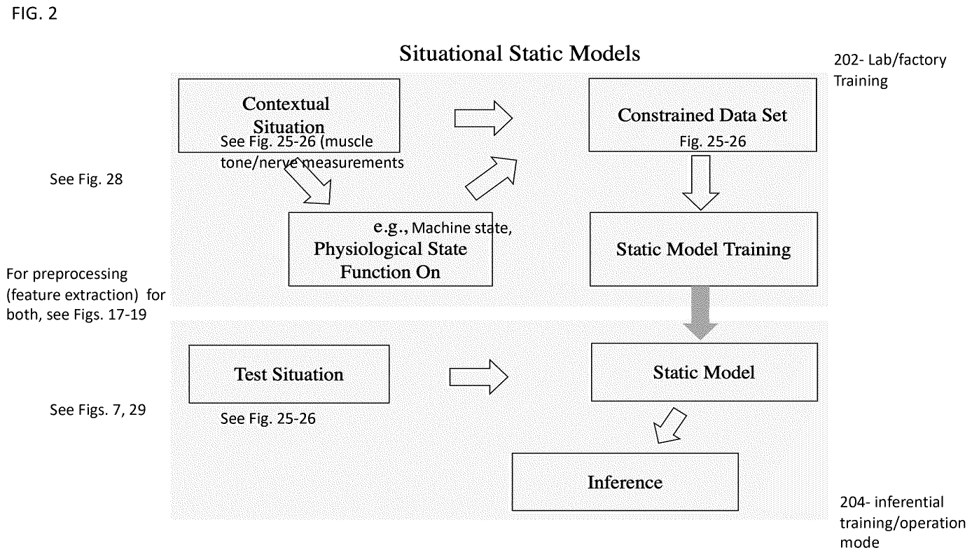

Neuro-muscular junction signals contain much more information than just user-specific invariants. They also contain situation-specific information that can be measured across a plurality of users. Such information may be then analyzed and modelized from raw data obtained in situation-constrained conditions. See FIG. 2 that shows overall processing flow of situational static models.

In those situation-specific conditions, those motions with a higher frequency of interest may be considered to be noise by others in the Art. Accordingly signals with either low frequencies (e.g., 12 or 30 Hz) but also at higher harmonics (up to 1500 or 4000 Hz) can be relevant as they contain the needed information.

Such STATIC models as mentioned can be used either as an improvement on the general field of Biometrics or be used on their own for situational awareness.

The raw signal, captured by a finger touchpad sensor in an electronic device or by an accelerometer of a hand-held electronic device, can have a number of unwanted signal frequencies in it. Accordingly, a type of filtration having a response to filter out signals outside the desired frequency range can be used to obtain a micro-motions signal from the raw electronic signal. Alternatively, an isolation/extraction means for signals in the desired frequency range may be used to obtain a micro-motions signal from the raw electronic signal. For example, a finite impulse response band-pass filter (e.g., the passband of 8 to 30 HZ) can be used to select the low signal frequency range of interest in a raw electronic signal sensed by a touchpad or accelerometer. Alternatively, a low-pass filter (e.g., 30 Hz cutoff) and a high-pass filter (e.g., 8 Hz cutoff) or a high-pass filter (e.g., 8 Hz cutoff) and a low-pass filter (e.g., 30 Hz cutoff) can be combined in series to achieve a similar result.

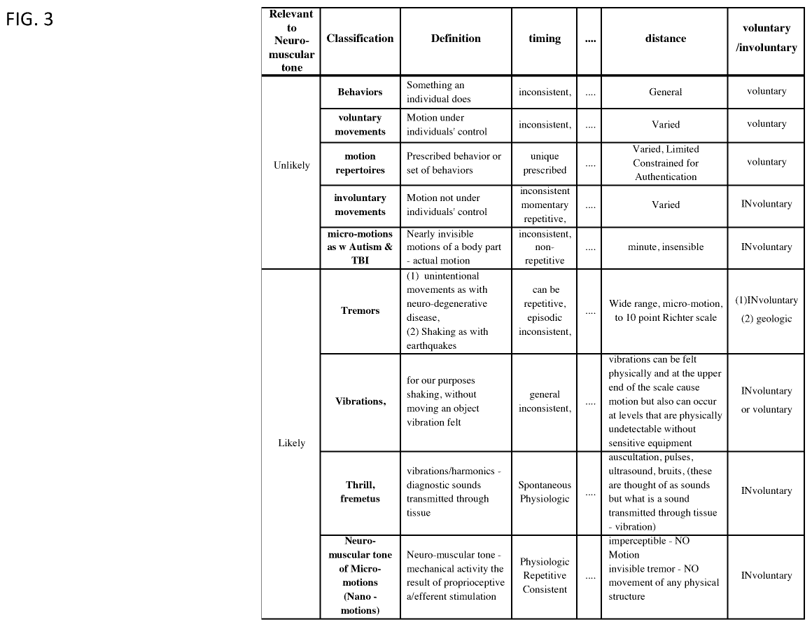

FIG. 3 shows one example of various types of motion classification according to some embodiments. This exemplary classification table provides a better understanding of what kinds of characteristics should be considered and measured to extract or filter from the user's acquired motion signal to obtain feature data related to the neuro-muscular tone signals.

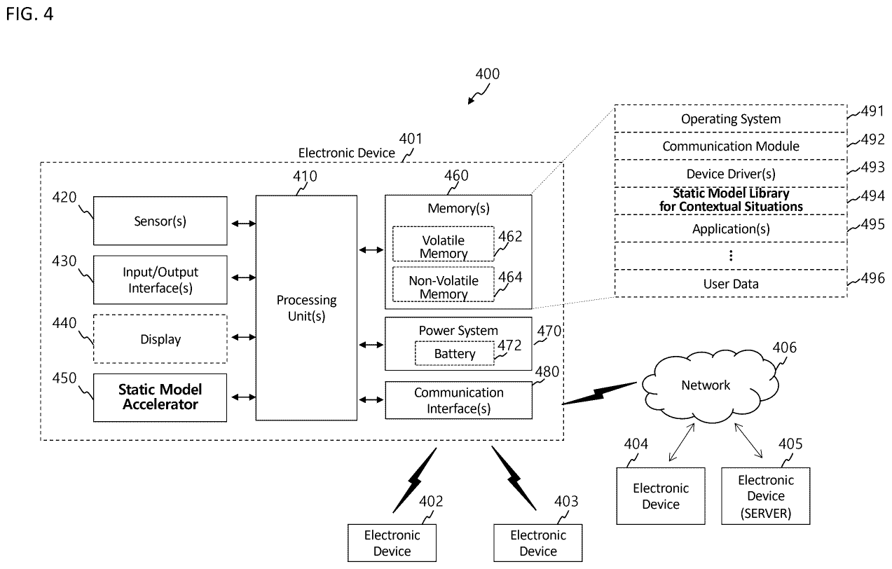

FIG. 4 is a block diagram of electronic devices illustrating exemplary operating environment 400 in accordance with some embodiments.

The electronic device 401 may include a processing unit 410, a sensor 420, an input/output interface 430, a display 440, a Static Model Accelerator 450, a memory 460, a power system 470, a communication interface 480 and so on. The electronic devices 401, 402, 403, 404, 405 may communicate with each other and be connected through a network 406 or the communication interface 480.

It is appreciated that this is merely an example of some embodiments of the disclosure. The electronic devices 401, 402, 403, 404, 405 can include more or fewer components than shown in FIG. 4, two or more components can be combined together, or a certain part of components can be mixed together differently in FIG. 4. The various components shown in FIG. 4 can be implemented in hardware, software, or a combination of hardware and software.

The processing unit 410 may include at least one central processing unit and the central processing unit may include at least one processing cores. The processing unit 410 may further include at least one or more of co-processors, communication processors, digital signal processing cores, graphics processing cores, low-power sensor control processors, special purpose controller and so on. In addition, various hierarchical internal volatile and nonvolatile memories can be included to perform functions such as an initial booting procedure, an operation for communicating with an external electronic device, an operation for downloading an initial booting or loader related program from an external electronic device, an interrupt operation, an operation for improving performance of an electronic device in a runtime operation of program and so on. The processing unit can load program instructions from a memory, a communication module or external sources, decode the instructions, execute an operation or a data processing, store result according to the decoded instructions, or perform static model processing for contextual situations including physiological states of the users which can be liveliness, blood glucose levels, stress hormone levels, presence of drugs, identifiers and so on. The term processing unit may be often called, by those of ordinary skill in the art, as a processor, an application processor (AP), a central processing unit (CPU), an MCU (Micro Controller Unit), a controller and so on.

The sensor 420 can sense or measure the state or physical quantity of the electronic device and convert it into an electric signal. The sensor 420 may include an optical sensor, an RGB sensor, an IR sensor, a UV sensor, a fingerprint sensor, a proximity sensor, a compass, an accelerometer sensor, a gyro sensor, a barometer, a grip sensor, a magnetic sensor, an iris sensor, a GSR (Galvanic Skin Response) sensor, an EEG (Electroencephalography) sensor, an ECG (Electrocardiogram) sensor, an EMG (Electromyography) sensor, an EKG (Electrocardiogram) sensor, external/internal electrode and so on. The sensor 420 may collect signals (e.g., motion signals, neuro-muscular tone, etc.) from a part of the user's body and transmit them to at least one component of the electronic device 401 including the processing unit 410 or the Static Model Accelerator 450 and then may perform static model processing for contextual situations including physiological states of the users which can be liveliness, blood glucose levels, stress hormone levels, presence of drugs, identifiers and so on.

The input/output interface 430 may include an input interface and an output interface. The input interface receives input from a user or an external device of the electronic device 401 in the form of input including signals and/or instructions and transfers the input to the component of the electronic device. The output interface transfers an output signal through the components of the electronic device 401 or to the user. For example, the input/output interface may include an input button, an LED, a vibration motor, various serial interfaces (e.g., USB (Universal Serial Bus), UART (Universal asynchronous receiver/transmitter), HDMI (High Definition Multimedia Interface), MHL (Mobile High-definition Link), IrDA (Infra-red Data Association), or etc.) and so on.

The display 440 can display various contents such as images, texts, or videos to the user. The display 440 may be a liquid crystal display (LCD), an organic light emitting diode (OLED) display, a hologram output device and so on. The display 440 may include a display driver IC (DDI) or a display panel. The display driver IC can transmit an image driving signal corresponding to the image information received from the processing unit 410 to a display panel, the image can be displayed according to the predetermined frame rate. The display driver IC may be implemented in an IC type and may include components such as a video memory capable of storing image information, an image processing unit, a display timing controller, a multiplexer and so on. The display 440 may include an input device such as a touch recognition panel, an electronic pen input panel, a fingerprint sensor, a pressure sensor and so on, or an output device such as a haptic feedback component. According to the specification of the electronic device 401, the display 440 may not be selectively included or may include at least one light emitting diode in a very simple form factor. The display 440 may display a position at which the user contacts a part of the user's body, a status indicator that describes acquisition start status, processing status, or completion status of gathering signals (e.g., motion signals, neuro-muscular tone, etc.) and by doing this, it makes the electronic device perform static model processing for contextual situations including physiological states of the users which can be liveliness, blood glucose levels, stress hormone levels, presence of drugs, identifiers and so on.

The memory 460 may include at least one of volatile memory 462 (e.g., DRAM (Dynamic RAM), SRAM (Static RAM), SDRAM (Synchronous Dynamic RAM)) and non-volatile memory 464 (e.g., NOR flash memory, NAND flash memory, EPROM (Erasable and Programmable ROM), EEPROM (Electrically Erasable and Programmable ROM), HDD (Hard Disk Drive), SSD (Solid State Drive), SD (Secure Digital) Card memory, Micro SD Card memory, MMC (Multimedia Card)). At least one or more of boot loaders, an operating system 491, a communication function 492 library, a device driver 493, a Static Model library for Contextual Situations 494, an application 495, or user data 496 can be stored in the non-volatile memory 464. When the electronic device is supplied with power the volatile memory 462 starts operating. The processing unit 410 can load programs or data stored in the nonvolatile memory into the volatile memory 462. By interfacing with the processing unit 410 during operation of the electronic device, the volatile memory 462 can play a role of main memory in the electronic device.

The power system 470 may serve to supply, control and manage power to the electronic device 401. The power system may include a PMIC (Power Management Integrated Circuit), a battery 472, a charging IC, a fuel gauge and so on. The power system can receive AC or DC power as a power source. The power system 470 can provide wired and wireless charging functions to charge the supplied power to the battery 472.

The wireless communication interface 480 may include, for example, cellular communication, Wi-Fi communication, Bluetooth, GPS, RFID, NFC and so on and may further include an RF circuitry unit for wireless communication. The RF circuitry unit may include an RF transceiver, a PAM (Power Amp Module), a frequency filter, an LNA (Low Noise Amplifier), an antenna and so on.

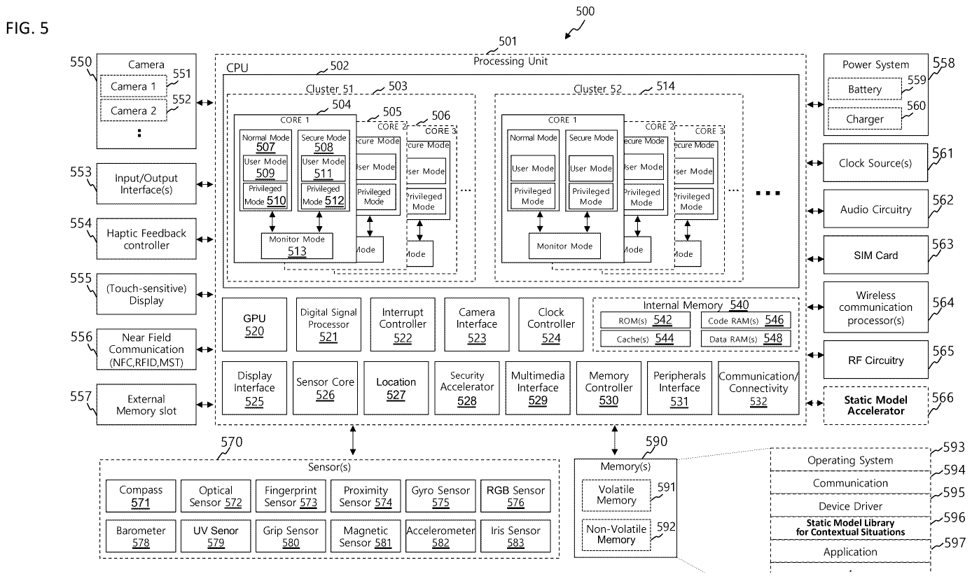

FIG. 5 is a block diagram of an exemplary electronic device in accordance with some embodiments. The electronic device 500 may include a processing unit 501, a camera 550, an input/output interface 553, a haptic feedback controller 554, a display 555, a near field communication 556, an external memory slot 557, a sensor 570, a memory 590, a power system 558, a clock source 561, an audio circuitry 562, a SIM card 563, a wireless communication processor 564, a RF circuitry 565, a Neuro-Print (NP) accelerator 566 and so on.

It may be appreciated that the electronic device is merely one example of the embodiment of the disclosure. The electronic device optionally may have more or fewer components than shown, optionally may combine two or more components, or optionally may have a different arrangement or configuration of the components. The various components shown in FIG. 5 may be implemented in hardware, software or a combination of both hardware and software.

The processing unit 501 may include at least one central processing unit 502 and the central processing unit may include at least one processing core. The processing unit 501 may further include at least one or more of co-processors, communication processors, digital signal processing cores, graphics processing cores, low-power sensor control processors, special purpose controller and so on. The processing unit 501 may be implemented as an SoC (System On Chip) including various components in the form of a semiconductor chip. In one embodiment, the processing unit 501 may comprise a graphics processing unit (GPU) 520, a digital signal processor (DSP) 521, an interrupt controller 522, a camera interface 523, a clock controller 524, a display interface 525, a sensor core 526, a location controller 527, a security accelerator 528, a multimedia interface 529, a memory controller 530, a peripherals interface 531, a communication/connectivity 532, an internal memory 540 and so on. In addition, various hierarchical internal volatile and nonvolatile memories can be included to perform functions such as an initial booting procedure, an operation for communicating with an external electronic device, an operation for downloading an initial booting or loader related program from an external electronic device, an interrupt operation, or an operation for improving performance of an electronic device in a runtime operation of program and so on. The processing unit can load program instructions from a memory 590, a communication/connectivity 532, or wireless communication processor 564, can decode the instructions, execute an operation or a data processing, store result according to the decoded instructions, or perform static model processing for contextual situations including physiological states of the users which can be liveliness, blood glucose levels, stress hormone levels, presence of drugs, identifiers and so on. The term processing unit may be often called, by a person having ordinary skill in the art, as a processor, an application processor (AP), a central processing unit (CPU), a micro controller unit (MCU), a controller and so on.

The central processing unit 502 may include at least one processor core 504, 505, 506. The central processing unit 502 may include a processor core having relatively low power consumption, a processor core having high power consumption with high performance and at least one or more core clusters including multiple cores, for example, a first cluster 503 or a second cluster 514. This structure is a technique that is used to improve the performance of the electronic device and the power consumption gain by allocating the core dynamically in consideration of the calculation amount and the consumed current in the multi core environment. Processor cores may be equipped with techniques to enhance security. ARM processors, one of the well-known mobile processors, have implemented this type of security technology on their processors called TRUSTZONE. For example, the first core 504, which is one physical processor core, can operate both in the normal mode 507 and the security mode 508. According to the mode, the processor's registers and interrupt processing mechanism can be operated separately so that access to resources (e.g., peripherals or memory areas) requiring security is allowed to access only in a secure mode. The monitor mode 513 may enable the mode switching between the normal mode 507 and the security mode 508. In the normal mode 507, the mode can be switched to the security mode 508 through a certain instruction or interrupt. The applications executed in the normal mode 507 and the security mode 508 are isolated between each other so that they cannot affect the applications executed in the respective modes, thereby allowing applications requiring high reliability to be executed in the security mode 508, consequently, the reliability of the system can be enhanced. It is possible to increase security by making it possible to execute a part of the operations in performing static model processing for contextual situations including physiological states of the users in the security mode 508.

The camera 550 may include a lens for acquiring an image, an optical sensor, an image signal processor (ISP) and so on and may acquire still images and moving images. And the camera 550 may include a plurality of cameras (e.g., the first camera 551, the second camera 552) to provide various functions associated with enhanced camera function.

The input/output interface 553 may include an input interface and an output interface. The input interface receives input from a user or an external device of the electronic device 500 in the form of input including signals and/or instructions and transfers the input to the component of the electronic device. The output interface transfers an output signal through the components of the electronic device 500 or to the user. For example, the input/output interface may include an input button, an LED, a vibration motor, various serial interfaces (e.g., universal serial bus (USB), universal asynchronous receiver/transmitter (UART), high definition multimedia interface (HDMI), mobile high-definition link (MHL), infra-red data association (IrDA)), or other known interfaces.

The haptic feedback controller 554 may include a vibration motor, which is usually called as an actuator, in order to provide the user with the ability to feel a certain sensation through a tactile sense.

The display (touch sensitive display) 555 can display various contents such as images, texts, and videos to the user. The display 555 may be a liquid crystal display (LCD), an organic light emitting diode (OLED) display, a hologram output device and so on. The display 555 may include a display driver IC (DDI) or a display panel. The display driver IC can transmit an image driving signal corresponding to the image information received from the processing unit 501 to a display panel, the image can be displayed according to the predetermined frame rate. The display driver IC may be implemented in an IC type and may include components such as a video memory capable of storing image information, an image processing unit, a display timing controller, a multiplexer and so on. The display 555 may include an input device such as a touch recognition panel, an electronic pen input panel, a fingerprint sensor, a pressure sensor and so on, or an output device such as a haptic feedback component. According to the specification of the electronic device 500, the display 555 may not be selectively included or may include at least one light emitting diode in a very simple form factor. The display 555 may display a position at which the user contacts a part of the user's body, a status indicator that describes acquisition start status, processing status, or completion status of gathering motion signals and by doing this, it makes the electronic device perform static model processing for contextual situations including physiological states of the users which can be liveliness, blood glucose levels, stress hormone levels, presence of drugs, identifiers and so on.

The near field wireless communication 556 may be implemented in a wireless communication system in order to perform communication with other electronic devices in close proximity such as Near Field Communication (NFC), Radio Frequency Identification (RFID), MST (Magnetic Secure Transmission) and so on.

The external memory slot 557 may include an interface capable of mounting a memory card (e.g., an SD card, a Micro SD card and so on) so as to expand the storage space of the electronic device 500.

The power system 558 may serve to supply, control and manage power to the electronic device 500. The power system may include a PMIC (Power Management Integrated Circuit), a battery 559, a charging IC 560, a fuel gauge and so on. The power system can receive AC or DC power as a power source. The power system 558 can provide wired and wireless charging functions to charge the supplied power to the battery 559.

The clock source 561 may include at least one of the system clock oscillators serving as a reference for the operation of the electronic device 500 and a frequency oscillator for transmitting and receiving an RF signal.

The audio circuit 562 may include an audio input unit (e.g., a microphone), an audio output unit (receiver, speaker, etc.) and/or a codec that performs a conversion between the audio signal and the electrical signal, thereby providing an interface between the user and the electronic devices. The audio signal can be obtained through the audio input unit may be converted into an analog electric signal and then can be sampled or digitized to be transmitted to another component (e.g., a processing unit) in the electronic device 500 to perform audio signal processing. The digital audio data transmitted from other components in the electronic device 500 may be converted into analog electric signals to generate audio signals through the audio output unit.

The SIM card 563 is an IC card that implements a subscriber identification module for identifying a subscriber in cellular communication. In most cases, a SIM card is mounted in a slot provided in the electronic device 510 and may be implemented in the form of an embedded SIM coupled to an electronic device, depending on the type of the electronic device. Each SIM card may have its own unique number and the unique number may include a fixed number ICCI (Integrated Circuit Identifier) and IMSI (International Mobile Subscriber Identity) information that varies from one subscriber line to another.

Wireless communication processor 564 may include, for example, cellular communication, Wi-Fi communication, Bluetooth, GPS and so on. Through the wireless communication processor 564, static model processing for contextual situations including physiological states of the users can be performed over the network in cooperation with at least one or more other electronic devices (including the server).

The RF circuit 565 may include a transceiver, a PAM (power amp module), a frequency filter, an LNA (low noise amplifier), an antenna and so on. It is possible to exchange control information and user data with the wireless communication processor and the processing unit to perform transmission and reception through a radio frequency in a wireless environment.

The Static Model Accelerator 566 may be used to increase the speed of performing computations that process signals obtained from a part of the user's body, or to increase the performance of the entire system by performing computations or some part of computations that are required to execute static model processing for contextual situations including physiological states of the users which can be liveliness, blood glucose levels, stress hormone levels, presence of drugs, identifiers and so on.

The sensor 570 can sense or measure the state, physical quantity, etc. of the electronic device and convert it into an electric signal. The sensor 570 may include a compass 571, an optical sensor 572, a fingerprint sensor 573, a proximity sensor 574, a gyro sensor 575, an RGB sensor 576, a barometer 578, a UV sensor 579, a grip sensor 580, a magnetic sensor 581, an accelerometer 582, an iris sensor 583 and so on. The sensor 570 can collect motion signals from portions of the user's body and transmits them to at least one component of the electronic device 500, including the processing unit 501, the Physiological States Accelerator 566 and can perform static model processing for contextual situations including physiological states of the users which can be liveliness, blood glucose levels, stress hormone levels, presence of drugs, identifiers and so on.

The memory 590 may include at least one of volatile memories 591 (e.g., DRAM (Dynamic RAM), SRAM (Static RAM), SDRAM (Synchronous Dynamic RAM)) and non-volatile memory 592 (e.g., NOR flash memory, NAND flash memory, EPROM (Erasable and Programmable ROM), EEPROM (Electrically Erasable and Programmable ROM), HDD (Hard Disk Drive), SSD (Solid State Drive), SD (Secure Digital) Card memory, Micro SD Card memory, MMC (Multimedia Card)). At least one or more of boot loaders, an operating system 593, a communication function 594 library, a device driver 595, a Static Model Library for Contextual Situations 596, an application 597, or user data 598 can be stored in the non-volatile memory 592. When the electronic device is supplied with power, the volatile memory 591 starts operating. The processing unit 501 can load programs or data stored in the non-volatile memory into the volatile memory 591. By interfacing with the processing unit 501 during operation of the electronic device, the volatile memory 591 can play a role of main memory in the electronic device.

The electronic device 500 may acquire a signal from the portion of the user's body via the sensor 570 and provide the acquired signal to at least one of the processing unit 501, Static Model Accelerator 566 and/or memory 590, through the interaction between these components, it is possible to perform static model processing for contextual situations including physiological states of the users which can be liveliness, blood glucose levels, stress hormone levels, presence of drugs, identifiers and so on. The static model processing for contextual situations including physiological states of the users may be performed independently by the electronic device 500 and may be performed over the network in cooperation with at least one or more other electronic devices.

### Feature Processing System

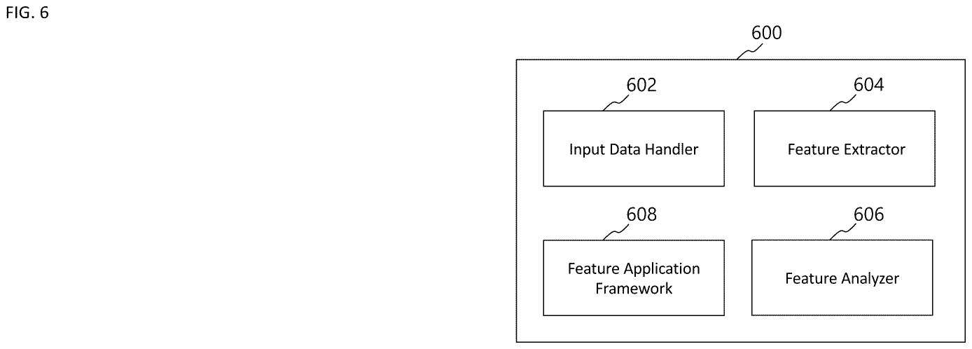

FIG. 6 depicts a block diagram of an embodiment of a Feature processing system 600. The Feature processing system 600 can perform the static model processing for contextual situations including physiological states of the users. The Feature processing system 600 can be implemented in the electronic device 500 in FIG. 5 or the electronic device 401 in FIG. 4 and additional hardware components or software modules can be used. The Feature processing system 600 can be configured in combination with at least one or more examples of the various embodiments described herein of each of the functions of FIG. 6. The Feature processing system 600 may include an Input Data Handler 602, a Feature Extractor 604, a Feature Analyzer 606, and a Feature Application Framework 608. The Feature processing system 600 may be implemented in hardware, implemented in software, or implemented in a combination of hardware and software.

In some embodiments, the Input Data Handler 602 may include various types of sensors including an acceleration sensor, a gyro sensor, a geomagnetic sensor, an optical sensor, an electroencephalography (EGE), an electrocardiogram (ECG), an electromyography (EMG), a galvanic skin response (GSR), and the like. Image information data may be obtained from a camera, and data may be collected and processed in the form of a computer file. The Feature Extractor 604 receives certain data from the Input Data Handler 602, performs preprocessing to remove unwanted signals or performs a specific process for processing efficiency, and perform extraction of numerical feature data representing a characteristic of the observed data. The Feature Analyzer 606 analyzes the feature data based on the characteristic feature data extracted by the Feature Extractor 604. When analyzing feature data, the feature data acquired from the Feature Extractor can be used, data in the form of computer files already collected through other paths can be analyzed, and the combination of these data can be analyzed. The Feature Analyzer 606 can derive information associated with the analyzed feature data and store this derived information. By using the information associated with the previously stored feature data, it is possible to derive an analysis result for the new input feature data. The Feature Application Framework 608 can utilize the result information of the Feature Analyzer 606 to perform identification, authentication, liveliness, encryption, or a function using the same.

### An Example of Static Model Operation

One of the contextual situations can be a physiological state of the users. The physiological measurements for the users that can be derived from accelerometer and gyroscope data:
Blood glucose levels
Female hormone levels
Stress hormone levels
Presence of drugs: alcohol, nicotine, caffeine, THC, CBD, prescription drugs etc.
Sleep deprivation
The presence of human neuro-muscular tremor or motion
The absence of human neuro-muscular tremor or motion

The scientific literature that shows how each of the above “physiological states” influence neuro-muscular tremors can be provided. These physiological states that manifest in accelerometer and gyroscope data contain certain frequency components, repetitive, non-repetitive, chaotic, and/or sinusoidal patterns that are quantifiable using preprocessing and feature extraction methods.

This static model for contextual situations including physiological states of the users can reside in the electronic device 401 or the electronic device 500, for example, in any embedded system, medical device, web application, or the like. The model is static in the sense that it does not require any interaction with outside training data to function effectively or to improve its detection. A static model quantifies whether a physiological state is present, the probability that a certain physiological state is present, or the degree to which a physiological state is present. These static models respect user privacy by not aggregating data aside from the initial training set.

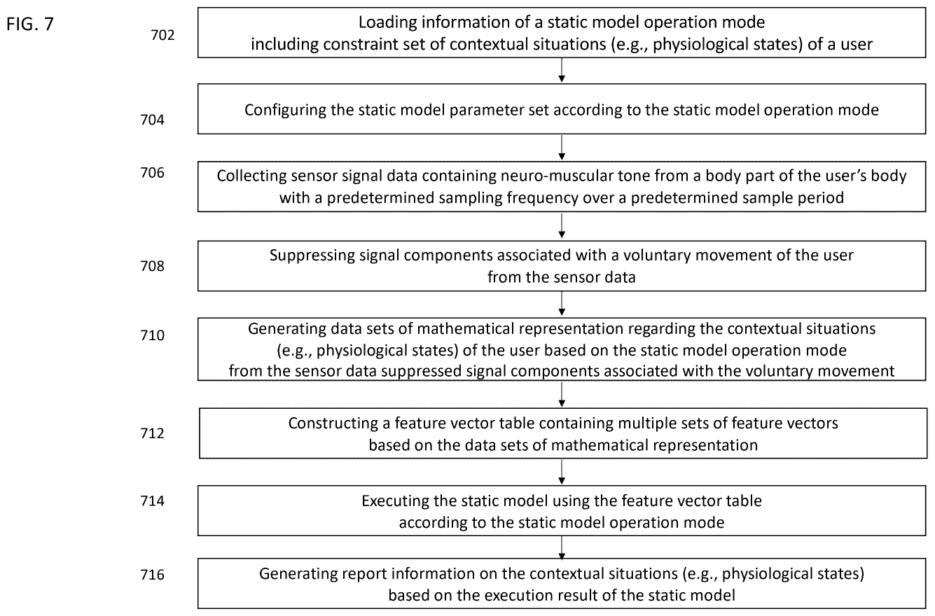

FIG. 7 is an example of a flow chart of static model operation for contextual situations (e.g., physiological states) of the user on the electronic device 401 or the electronic device 500. The electronic device 401, 500 can load information of a static model operation mode including constraint set of contextual situations (e.g., physiological states) of a user, configure the static model parameter set according to the static model operation mode, collecting sensor signal data containing neuro-muscular tone from a body part of the user's body with a predetermined sampling frequency over a predetermined sample period, suppress signal components associated with a voluntary movement of the user from the sensor data, generate data sets of mathematical representation regarding contextual situations (e.g., physiological states) of the user based on the static model operation mode from the sensor data suppressed signal components associated with the voluntary movement, construct a feature vector table containing multiple sets of feature vectors based on the data sets of mathematical representation, execute the static model using the feature vector table according to the static model operation mode and generate report information on the contextual situations (e.g., physiological states) based on the execution result of the static model.

In some embodiments, the constraint sets of contextual situations (e.g., physiological states) can be blood glucose levels, female hormone levels, stress hormone levels, presence of drugs (alcohol, nicotine, caffeine, THC, CBD, prescription drugs, etc.), sleep deprivation, the presence of human neuro-muscular tremor or motion, the absence of human neuro-muscular tremor or motion and so on. Information of a static model operation mode including the constraint sets of physiological states of a user can be stored in memory 460, 590, or be downloaded over the communication from the server computer prior to the FIG. 7 operation. In some embodiments, the user can select at least one of the constraint sets of contextual situations (e.g., physiological states) for the static model operation or an application program can automatically select the constraint sets of contextual situations (e.g., physiological states) according to the application program purpose.

### Static Model Processing System for Contextual Situations

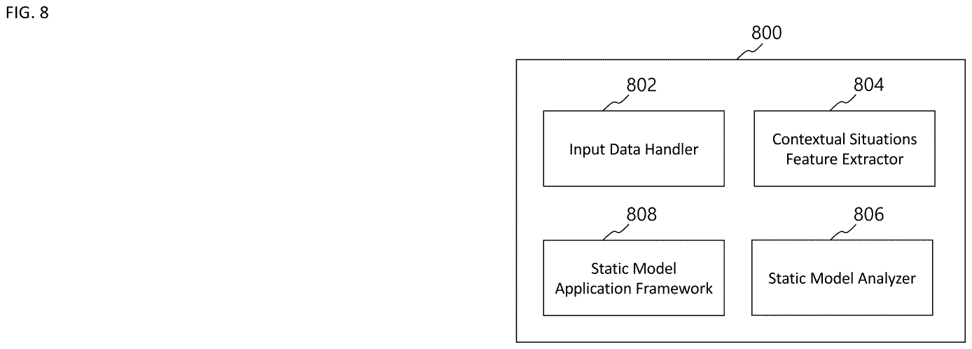

FIG. 8 depicts a block diagram of an embodiment of a Static Model processing system 800. In some embodiments. The Static Model processing system 800 can be implemented in the electronic device 500 in FIG. 5 or the electronic device 401 in FIG. 4 and additional hardware components or software modules can be used. The Feature processing system 600 of FIG. 6 can also be implemented in the form of the Static Model processing system 800 that processes physiological states such as FIG. 8. The Static Model processing system 800 may be configured in combination with at least one or more examples of the various embodiments described herein. The Static Model processing system 800 may include an Input Data Handler 802, a Contextual Situations Feature Extractor 804, a Static Model Analyzer 806, and a Static Model Application Framework 808. The Static Model processing system 800 may be implemented in hardware, implemented in software, or implemented in a combination of hardware and software. The Static Model processing system 800 may be in the form of software that is executed in the electronic device 401 of FIG. 4 or the electronic device 500 of FIG. 5. Some components of the Static Model processing system 800 may be implemented in the electronic device 401 or the electronic device 500 in the form of software associated with a special purpose hardware accelerator.

In some embodiments, the Input Data Handler 802 can collect data from various types of sensors including an acceleration sensor, a gyro sensor, a geomagnetic sensor, an optical sensor, an electroencephalography (EEG), an electrocardiogram (ECG), an electromyography (EMG), an electrocardiogram (EKG), an external/internal electrode, a galvanic skin response (GSR), an electro-magnetic sensing (EMS) and the like. Image information data may be obtained from a camera, and data may be collected and processed in the form of a computer file. The Contextual Situations Feature Extractor 804 receives certain data from the Input Data Handler 802, performs preprocessing to remove unwanted signals or performs a specific process for processing efficiency, and perform extraction of numerical feature data representing a characteristic of the observed data. The Static Model Analyzer 806 analyzes the feature data based on the characteristic feature data extracted by the Contextual Situations Feature Extractor 804. When analyzing feature data, the feature data acquired from the Contextual Situations Feature Extractor can be used, data in the form of computer files already collected through other paths can be analyzed, and the combination of these data can be analyzed. The Static Model Analyzer 806 can derive information associated with the analyzed feature data and store this derived information. By using the information associated with the previously stored feature data, it is possible to derive an analysis result for the new input feature data. The Static Model Application Framework 808 can utilize the result information of the Static Model Analyzer 806 to perform static model processing for contextual situations including physiological states of the users which can be liveliness, blood glucose levels, stress hormone levels, presence of drugs, identifiers and so on.

### (1) The Input Data Handler 802

In some embodiments, the Input Data Handler 802 can collect data from various types of sensors including an acceleration sensor, a gyro sensor, a geomagnetic sensor, an optical sensor, an electroencephalography (EEG), an electrocardiogram (ECG), an electromyography (EMG), an electrocardiogram (EKG), an external/internal electrode, a galvanic skin response (GSR), an electro-magnetic sensing (EMS) and the like. Image information data may be obtained from a camera, and data may be collected and processed in the form of a computer file.

In some embodiments, the Input Data Handler 802 may collect a movement signal data from a body part of the user's body that can be obtained by the sensor of electronic device 500. The sensor May include a sensor capable of detecting a user's movement or vibration. For example, the sensor may include a compass 571, a gyro sensor 575, an acceleration sensor 582, a geomagnetic sensor, a camera 550, an optical sensor, a touch sensor of the touch sensitive display 555, an electroencephalography (EEG), an electrocardiogram (ECG), an electromyography (EMG), an electrocardiogram (EKG), an external/internal electrode, a galvanic skin response (GSR), an electro-magnetic sensing (EMS) or a combination thereof.

The sensor can sense motions, vibrations, movement associated with neuro-muscular derived signals and the like that are generated in a portion of the user's body that is in contact with the electronic devices. Movements or micro movements associated with neuro-muscular derived signals can be sensed in the form of analog electrical signals in the sensor. For example, in the case of a sensor made using MEMS technology, the physical quantity that is changed by the force of movement generated in contact with a part of the user's body can be measured as an electrical analog signal using a method such as capacitance, piezoelectric, piezo resistive or thermal sensing.

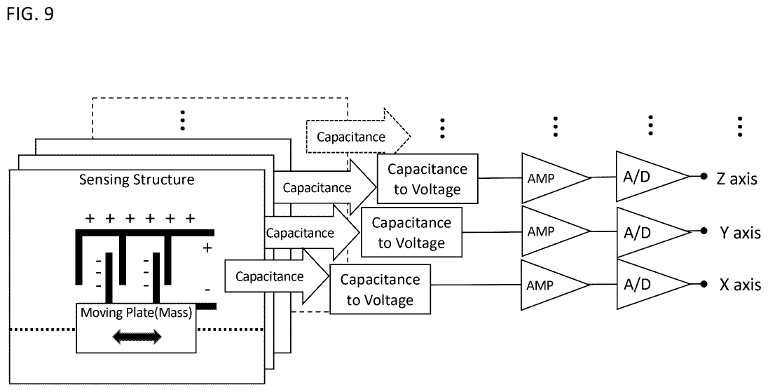

FIG. 9 shows an example of the sensing structure in the sensor on the electronic device 401 or the electronic device 500. Acceleration or angular velocity actually measures the force exerted on a substance and indirectly measures the acceleration or angular velocity through forces applied from the outside of the substance. Therefore, the micro motion or micro movement of the muscle caused by the neuro-derived mechanism is transmitted as a force applied to the electronic device, and the measured force may be indirectly calculated in the form of acceleration or angular velocity. An external force is applied from the outside of the electronic device to which the sensor is attached, and the moving plate (MASS) of FIG. 9 moves and the change of capacitance occurs because the distance of the electrode in the sensing structure changes. The changed capacitance is converted into the form of analog voltage and an analog voltage signal is applied to the input of the A/D converter via an amplifier. Multiple of the sensing structure can make it possible to measure multiple axes' values of the acceleration and angular velocity and these values can be used for more sophisticated applications. The measured electrical analog signal may be sampled by a predefined sampling frequency for a predefined period (e.g., 3, 5, 10, 20, 30 seconds, etc.) in the A/D converter.

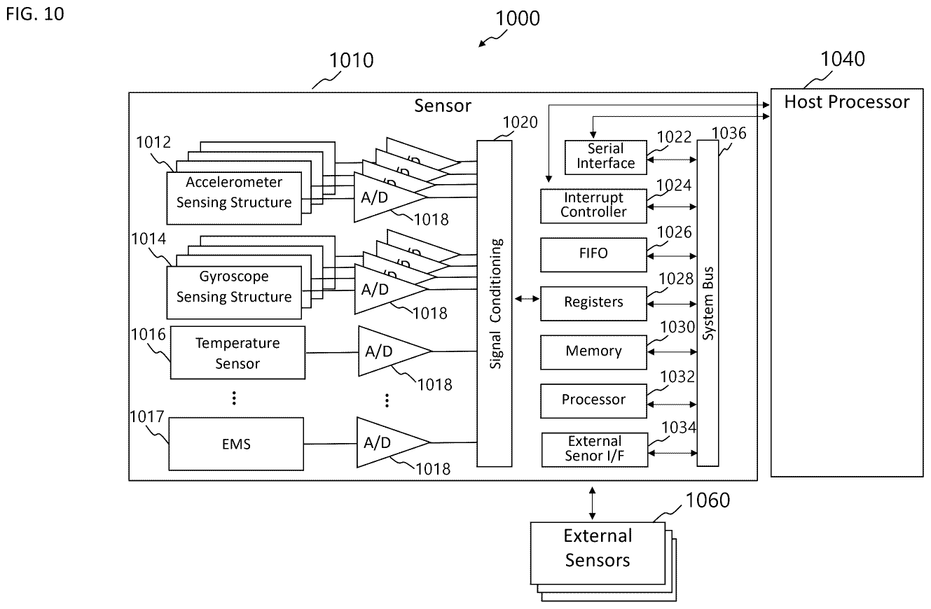

FIG. 10 shows the block diagram of the sensor on the electronic device 401 or the electronic device 500. The Sensor 1010 may include an Acceleration Sensing Structure 1012, a Gyroscope Sensing Structure 1014, a Temperature Sensor 1016, an EMS 1017, an A/D converter 1018, a Signal Conditioning 1020, a Serial interface 1022, an Interrupt Controller 1024, a FIFO 1026, a Registers 1028, a Memory 1030, a Processor 1032, an External Sensor Interface 1034 and a System bus 1036.

The Acceleration Sensing Structure 1012 may include a plurality of sensing structures to measure the acceleration of a plurality of axes. The acceleration measured in the acceleration sensing structure can be analog output in the form of analog voltage and it can be converted into digital data through an A/D converter. Measured acceleration from the Acceleration Sensing Structure 1012 may be drifted to the temperature change due to a characteristic of material consist of sensing structure. The drift of sensing value can be compensated with the help of the temperature sensor 1016. The Signal Conditioning 1020 may include a signal processing filter required for signal processing to improve signal quality. The processor 1032 can control the configuration of the signal processing filter. Acceleration values measured may be stored in the Registers 1023 through Signal Conditioning 1020. The acceleration values stored in the Registers 1023 can be recorded in the range of ±2 g, ±4 g, ±8 g, ±16 g depending on the predefined configuration.

The Gyroscope Sensing Structure 1014 may include a plurality of sensing structures to measure the rotation of a plurality of axes. The rotation measured in the Gyroscope Sensing Structure 1014 can be analog output in the form of analog voltage and it can be converted into digital data through an A/D converter. Measured rotation from the Gyroscope Sensing Structure 1014 may be drifted to the temperature change due to a characteristic of material consist of sensing structure. The drift of sensing value can be compensated with the help of the temperature sensor 1016. The Signal Conditioning 1020 may include a signal processing filter required for signal processing to improve signal quality. The processor 1032 can control the configuration of the signal processing filter. Rotation values measured may be stored in the Registers 1023 through the Signal Conditioning 920. The rotation values stored in the Registers 1023 can be recorded in the range of +125, +250, +500, +1000, +2000 degrees/sec depending on the predefined configuration.

By implementing the FIFO 1026 structure in the Sensor 1010, the Host Processor 1040 does not need to constantly monitor the sensor data, thereby reducing the current consumption of the electronic device. The host processor 1040 may be a processing unit 410 of the electronic device 401 and a processing unit 501 of the electronic device 500. Data sensed by the sensor may be delivered to the Host Processor 1040 through the Serial Interface 1022. The Serial Interface 1022 also allows the Host Processor 1040 to set the sensor's control registers. The Serial interface 1022 may include SPI, 12C, and the like. The Interrupt Controller 1022 can configure an external interrupt pin connected to the Host Processor 1040, interrupt latching and clearing method, and send an interrupt trigger signal to the host processor 1040. An interrupt signal can be triggered when the sensor data is ready, or when the data is ready in the FIFO to be read by the host processor 1040. In addition, when an additional sensor is connected through the external sensor interface 1034 to reduce power consumption of the entire electronic device system, an interrupt may be triggered even when the host processor 1040 reads data from an external predecessor. In order to reduce the power consumption of the electronic device, the Host Processor 1040 may enter a sleep mode, and if the data is not prepared from the external sensor 1060 connected to the sensor 1010, the Host Processor 1040 may remain in the sleep mode continuously. When the sensor data is ready, the sensor 1010 can also act as a sensor core or sensor hub by waking the host processor through the sensor's interrupt and enabling the necessary data processing for the Host Processor 1040.

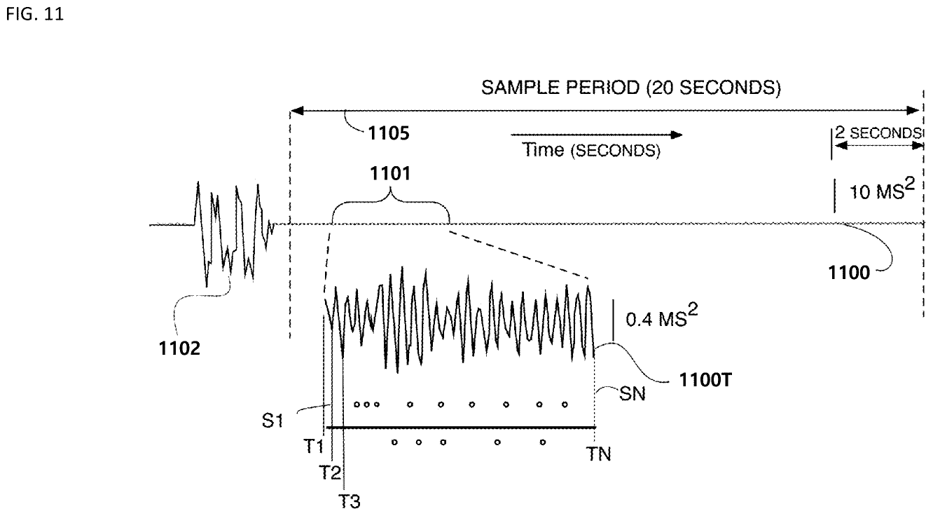

Referring to FIG. 11, is a plot of an acceleration waveform 1100 of a hand acceleration signal for a single axis (X, Y, or Z) shown over time. A portion 1101 of the hand acceleration waveform 1100 is magnified as waveform 1100T as shown. While analog signal waveforms may be shown in the drawings, it is understood that analog signal waveforms may be sampled over time and represented by a sequence of digital numbers at discrete periodic timestamps (a “digital waveform”). While an accelerometer senses acceleration over time, if a sensor senses displacement over time instead, it may be converted into acceleration by twice differentiating the displacement signal with time.

The hand acceleration for each axis is sampled over a predetermined sample time period 1105, such as 5, 10, 20 or 30 second time spans for example. The sampling frequency is selected so that it is compatible with the filtering that follows. For example, the sampling frequency may be at 250 Hz (4 milliseconds between samples). Alternatively, the sampling frequency can be 330 Hz or 200 Hz, for example. The sampling may be performed on an analog signal by a sampling analog to digital converter to generate the samples S1-SN represented by a digital number over the time stamps T1-TN during the given predetermined sample time period. Assuming a 20 second sample time period and a sampling frequency of 250 Hz, a dataset for acceleration would include 3 (3 axes) times 5000 samples over the time period for a total of 15 k samples.

In some embodiments, since the intrinsic neuro-muscular tone of the human can be observed mainly in the range of 3 Hz to 30 Hz, sampling frequency of the input data hander 802 can be, for example, 60 Hz, 200 Hz, 250 Hz, 330 Hz, 400 Hz and so on, which is more than twice the 30 Hz frequency. The collected data of the Input Data Handler 802 may further perform an operation of removing noise or improving signal quality to improve signal quality. The analog value sampled by the predefined sampling frequency may be converted into a digital signal through a quantization process in the A/D converter 1018. In the quantization process, quantization may be performed according to a predefined bit rate. When performing quantization, linear quantization can be performed with a constant quantization width, and nonlinear quantization, which expands or compresses the quantization width according to a predefined value in a certain range, can be used to obtain a high-quality signal-to-noise ratio for an application.

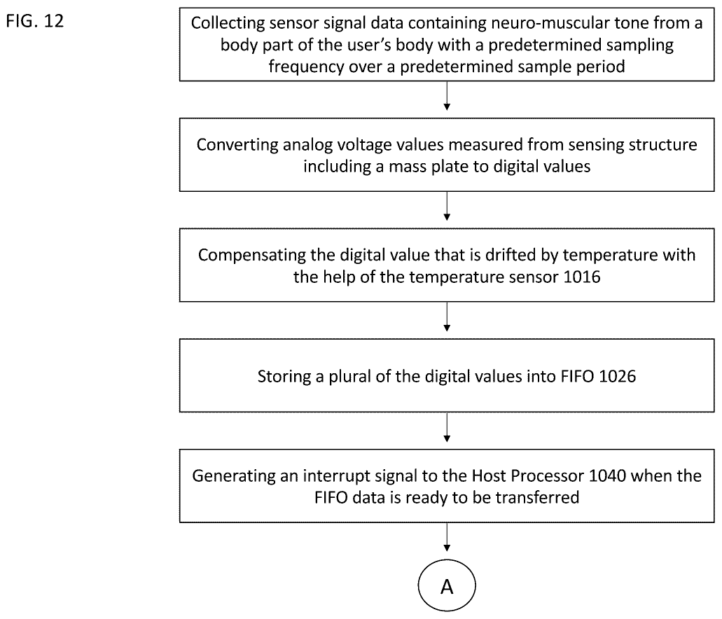

FIG. 12 is an example of a flow chart of collecting a movement signal data of Input Data Handler 802 on the electronic device 401 or the electronic device 500. The electronic device can collect sensor signal data containing neuro-muscular tone from a body part of the user's body with a predetermined sampling frequency over a predetermined sample period, converts analog voltage values measured from sensing structure including a mass plate to digital values, compensate the digital value that is drifted by temperature with the help of the temperature sensor 1016, store a plural of the digital values into FIFO 1026, and generates interrupt signal to the Host Processor 1040 when the FIFO data is ready to be transferred.

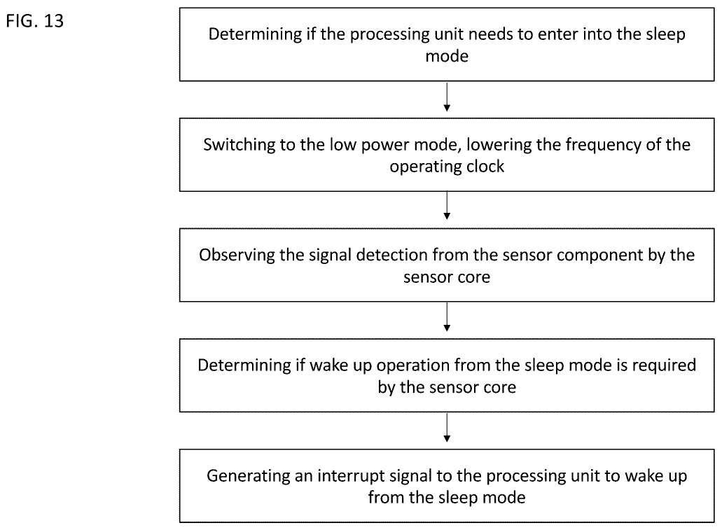

FIG. 13 is an example of a flow chart of sleep mode operation of the Static Model processing system 800 on the electronic device 401 or the electronic device 500. In some embodiments, when the electronic device 401, 500 is implemented as a portable device, the power consumption may become important issues. The electronic device 401, 500 may operate in a sleep mode. When the electronic device operates in the sleep mode, various methods can be applied such as shutting down the power of some components in the electronic device 401, 500, switching to the low power mode, lowering the frequency of the operation clock for the minimum power consumption and so on. The power consumption efficiency may be increased when the processing unit 501 enters the sleep mode. However, since the delay may occur in terms of the mutual response of the user and the electromagnetic in sleep mode, a coprocessor such as the sensor core 526 may be included inside the processing unit or in the electronic device. Even when the processing unit 501 enters the sleep mode, the sensor core 526 can continuously observe the signal detection from the sensors 570. When it is determined, by the sensor core 526, that processing of the processing unit 501 is required, the sensor core 526 can generate interrupt signal to the processing unit 501 and the processing unit 501 gets out of the sleep mode. At this time, the power can be supplied again to some of the components that were into sleep mode and the processing unit 501 exits from the low power mode and changes the frequency of the operation clock to be operated at the fast clock in order to wake up from the sleep mode.

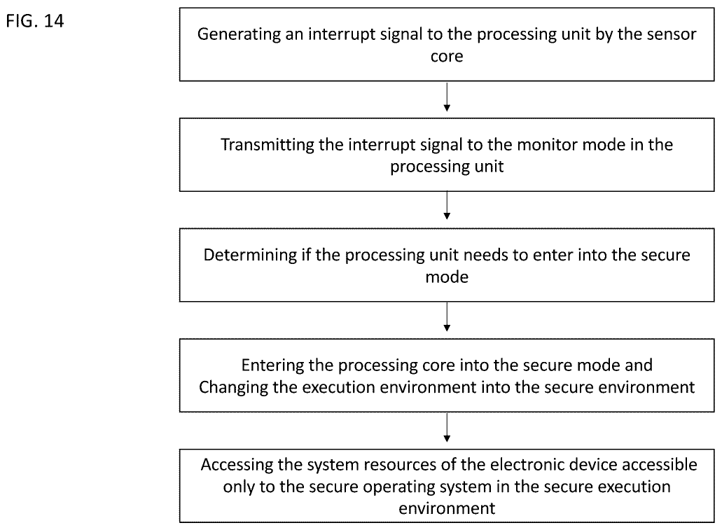

FIG. 14 is an example of a flow chart of secure mode operation of Static Model processing system 800 on the electronic device 401 or the electronic device 500. The Static Model processing for Contextual Situations can be considered an operation required security. In this case, the operation of handling data collection from the sensor may be operated by switching the first core 404 in the processor unit 501 to the secure mode 508. The signal transmitted by the sensor or the sensor core 526 via a bus or an interrupt can be transmitted to the monitor mode 513 to switch the first core 504 to the secure mode 508. When the execution mode of the first core 504 is switched to the secure mode, the execution environment for security runs isolated from the normal execution environment. The core entering the secure mode 508 can access or control the system resources of the electronic device accessible only to the secure operating system in the secure execution environment.

In some embodiments, the Input Data Handler 802 can identify data collection mode from the user. For example, the data acquisition mode can include a data acquisition mode for learning and a data acquisition mode for inference. In the acquisition mode for inference, the signal acquisition for training can be performed simultaneously to improve the performance of the previously trained model. When collecting data, a UI-related component may be displayed on the electronic device screen to collect data in a sitting posture, a standing posture, a walking posture, or the like. In addition, the UI-related components may be displayed so that the user can input by distinguishing the activity state such as whether the user is running, riding a bicycle, or riding in a car. In another embodiment, the collected data may be analyzed to determine a posture or an activity state of the user to process the corresponding information.

In some embodiments, in performing static model processing for contextual situations including physiological states of the users which can be liveliness, blood glucose levels, stress hormone levels, presence of drugs, identifiers and so on, the electronic device 401, 500 can be performed by assigning such the function to a cluster of high-performance processor cores. For example, if the first cluster 503 is a cluster of high-performance cores, the first cluster 503 can be assigned.

### (2) The Contextual Situations Feature Extractor 804

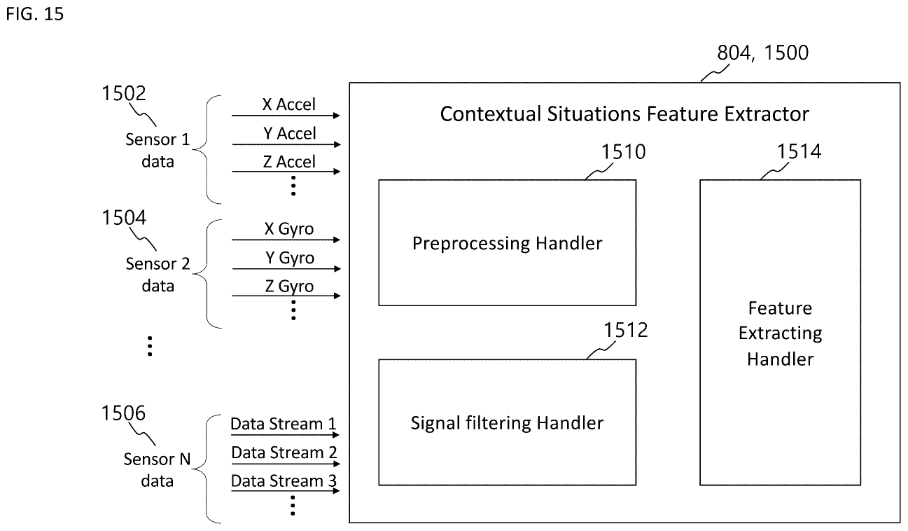

FIG. 15 shows the block diagram of the Contextual Situations Feature Extractor 1500. The Contextual Situations Feature Extractor 1500 can include a Preprocessing Handler 1510, a Signal Filtering Handler 1512 and a Feature Extracting Handler 1514.

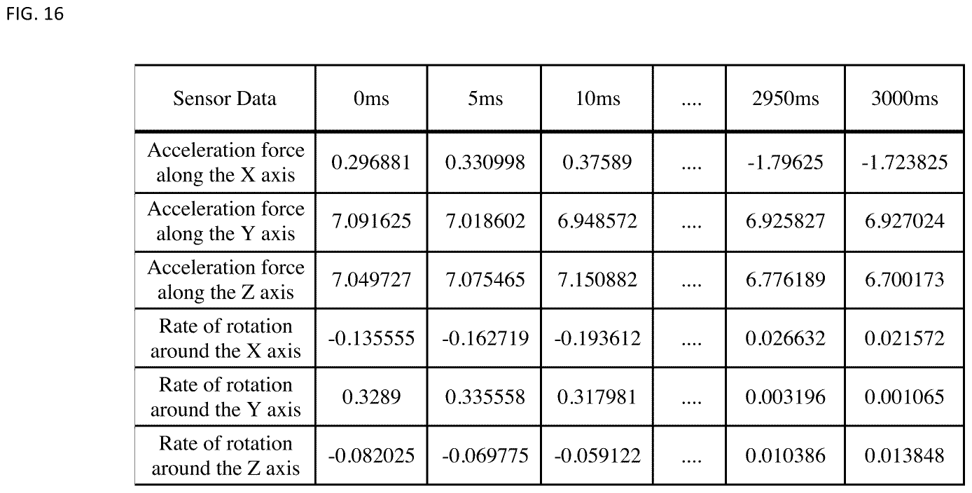

In some embodiments, the Contextual Situations Feature Extractor 804 can be configured as the Contextual Situations Feature Extractor 1500 of FIG. 15. The Contextual Situations Feature Extractor 804, 1500 can get numerical data such as the first sensor data 1502 and the second sensor data 1504 from the Input Data Handler 802. If the input data is received from the acceleration sensor or the gyroscope sensor, the numerical data can be collected as shown in FIG. 16. FIG. 16 is an example of various types of sensor data and format can be used herein.

The multidimensional sensor data may be referred to as raw data. Signal processing such as preprocessing, filtering, etc. can be performed on the raw data to achieve optimal performance in the next step.

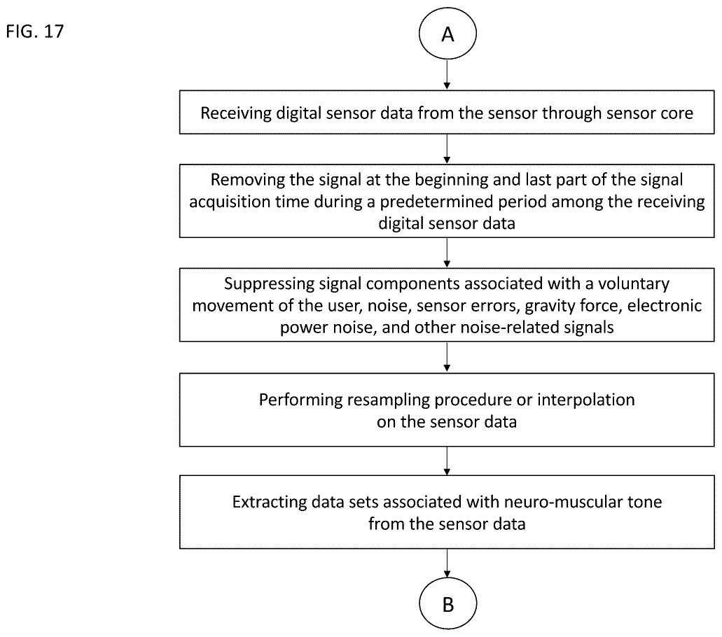

FIG. 17. is an example of a flow chart of a preprocessing operation for the Contextual Situations Feature Extractor 804, 1500 on the electronic device 401 or the electronic device 500.

In some embodiments, methods for performing preprocessing may be determined according to the use of the collected signal. For example, the collected signals can be used for authentication, posture estimation, and activity information estimation. The preprocessing method can be processed differently depending on the usage and partially overlapped. The preprocessing handler 1010, can check for the following input data:
sensor errors (spikes, saturation, flat signal)
user errors (shaking, squeezing phone)
static data (does not contain a dynamic range of “human” signal).
   The preprocessing handler 1010, can process the input data by determining the quality of the input data or determining it is an error (e.g., outside an expected range of data).

An input state machine operation can be performed according to the quality of the input data.

When it is determined that the quality of the input data is very low, an operation of collecting the input data may be performed again, or a user interface may be generated that requires a user to perform an additional operation in order to collect more input data. In the pre-processing process, in the signal obtained from the motion sensor for about 1 to 2 seconds at the beginning of the signal acquisition may include a large amount of the signal of the macro motion of the user and may be affected a lot by the shaking of the electronic device. As a result, the signal may be discarded at the beginning of the signal acquisition or at a certain interval immediately before the acquisition is completed.

In some embodiments, the Preprocessing Handler 1510 can perform resampling procedure or interpolation on input data. The resampling function can uniform or nonuniform data to new fixed rate data. The input data derived from sensors that are sampled at a high level of hardware abstraction and are subject to many variations depends on hardware components manufactured by a certain company or sampling configuration on the sensor component. As a result, input data from sensors written in the raw data format may be non-uniformly sampled. Input data can be corrected by a resampling procedure of the Preprocessing Handler 1510 to a new uniform rate before further analysis. The resample procedure can correct the small deviations in non-uniform samples through linear or cubic interpolation and provides a constant time between samples. For example, the resample procedure can use a cubic ‘spline’ to correct deviations in the sampling rate.

The one of example software code can be written as below.

$$\begin{matrix}[ Ax , T ] = resample ( Axyz ( : , 1 ) , time , ' spline ' ) ; \\ [ Ay , T ] = resample ( Axyz ( : , 2 ) , time , ' spline ' ) ; \\ [ Az , T ] = resample ( Axyz ( : , 3 ) , time , ' spline ' ) ;\end{matrix}$$

In some embodiments, the Signal Filtering Handler 1512, can perform following filtering processing on the input data.
Variety of band-pass filters
Reduce gravitational effects and behavioral effects in very low frequencies
Focus on a wide range of information in harmonics of signal

The Signal Filtering Handler 1512 can perform filtering to remove an unnecessary signal for micro motion data extraction from the collected signal. Unnecessary signals may include, for example, noise, macro motion signals, distortion due to gravity, and the like. Since the power noise may be often generated in the collected signal when the electronic device is being charged, the signal may be filtered in consideration of characteristics due to power noise. The frequency of neuro-muscular micromotions, derived from nerves or due to the inherent neuro-muscular anatomy of a human based nerve, can be observed mainly in the range of 3 Hz to 30 Hz. A signal in the range of 3 Hz to 30 Hz or 4 Hz to 30 Hz from the collected input motion data can be extracted by using a signal processing algorithm. Depending on the characteristics of the unwanted signal to be removed, it is possible to change the cutoff frequency of the bandpass filter of the signal processing algorithm. For example, in one embodiment, a signal in a range of 4 Hz to 30 Hz may be extracted, and in another embodiment, a signal in a range of 8 Hz to 30 Hz may be extracted. In another embodiment, signals in the range of 4 Hz to 12 Hz or 8 Hz to 12 Hz may be extracted.

The Signal Filtering Handler 1512 can use a signal processing that analyzes input data and then classifies/identifies input data as small signals and large signals which are separated out from the small signal amplitude of the micro-motions. Signal Filtering Handler 1512 can suppress/filter macro motion (large movements of the user's body, large movements of the arm or walking, running, jogging, hand gestures, etc.) from the collected input data. The example analysis may be of the form described in “Time Series Classification Using Gaussian Mixture Models of Reconstructed Phase Spaces” by Richard J. Povinelli et al., IEEE Transactions on Knowledge and Data Engineering, Vol. 16, No. 6, June 2004. Alternatively, a separation of the large signals due to voluntary motion may be made by using a BMFLC-Kalman filter as is described in “Estimation of Physiological Tremor from Accelerometers for Real-Time Applications” by Kalyana C. Veluvolu et al., Sensors 2011, vol. 11, pages 3020-3036.

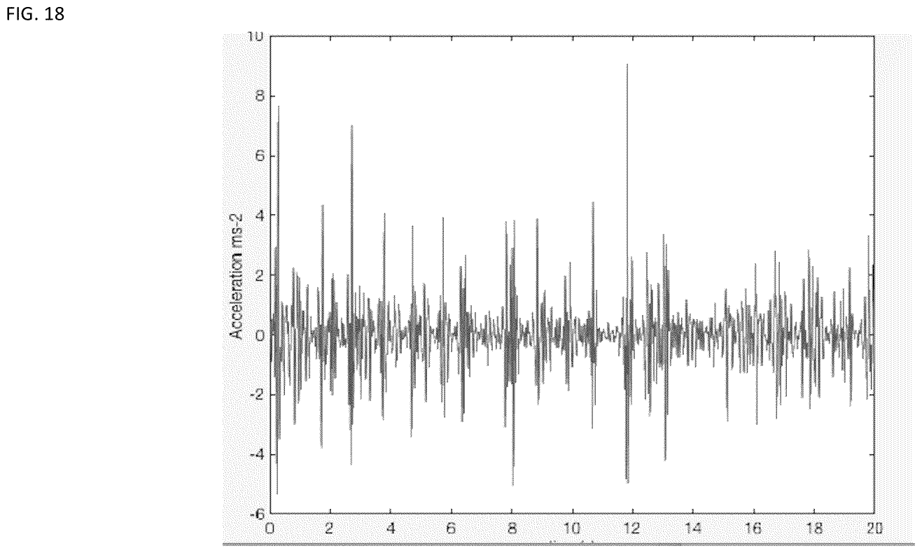

In some embodiments, the Feature Extraction Handler 1514 can extract unique characteristics from the extracted neuro-muscular micro motion data according to the static model operation mode. FIG. 18 shows examples of time series of a single axis Accelerometer data sample that shows crossings of the center axis based on the extracted neuro-muscular micro motion data generated and processed by the Preprocessing Handler 1510 and the Signal Filtering Hander 1512. These crossings can be indicative of physiological states and measured using mathematical functions such as the Barlow Feature. The Barlow Feature is commonly used in EEG electroencephalography analysis. The Barlow feature is one example of hundreds of potential features that can measure the presence of the physiological states. By taking the absolute value of the mean of the discrete difference along an axis of time series gyroscope or accelerometer data, the global tendency of a measured neuro-muscular tremor to cross a central line of origin can be quantified. This measurement alone, or in combination with any number of other features and preprocessing techniques can be used to train a static machine learning model.

In some embodiments, the scale of the signal data or the extracted feature data may differ according to the type and structure of the electronic device, the variation of the sensor component, the sampling frequency of the signal, the contact type between the user and the electronic device, and the like. For example, the signal data or the first feature data may be measured on a scale of 1 to 10, and the second feature data may be measured on a scale of 1 to 1000. In this case, standardization can be performed on the signal data or the feature data. In other words, the signal data or the feature data can be made into normal distribution by centering the data such that the standard deviation is one and the average is zero. A simple mathematical expression for standardization is shown below.

$${X}_{standard}^{( i )} = \frac{{X}^{( i )} - {μ}_{X}}{{σ}_{X}}$$

where μₓ is the sample mean of a particular feature data, and σₓ is the standard deviation.

In some embodiments, normalization may be performed instead of standardization as needed for processing components of the Static Model Analyzer, and both normalization and standardization may be used. In addition, normalization or standardization may be performed on the sensor data, may be performed on the feature data, or may be performed on all or part of the sensor data or the feature data. The normalization or standardization process may be skipped depending on the characteristics of the sensor data or the feature data.

In some embodiments, it might be necessary to reduce the number of large numbers of data to improve the overall performance of the system. The initial step can include a step of subtracting each data value from the mean of measured data so that its empirical mean is zero and each variance of data is equal to one. After this initial step, based on the correlation between data, the direction of maximal variance in high-dimensional data can be found and the number of data can be reduced by projecting them into new subspaces with the same or smaller dimensions than the original. A simple procedure can be to standardize on n-dimensional data, create a covariance matrix, decompose it into eigenvectors and eigenvalues, and select the eigenvector that corresponds to the largest eigenvalue to produce a projection matrix. After creating the projection matrix, in order to reduce the dimension of the n-dimensional data, a transformation through the projection matrix can be performed to the signal data or the feature data. These above processes can convert a set of the extracted data sets associated with neuro-muscular tone to a set of data having linearly uncorrelated characteristics.

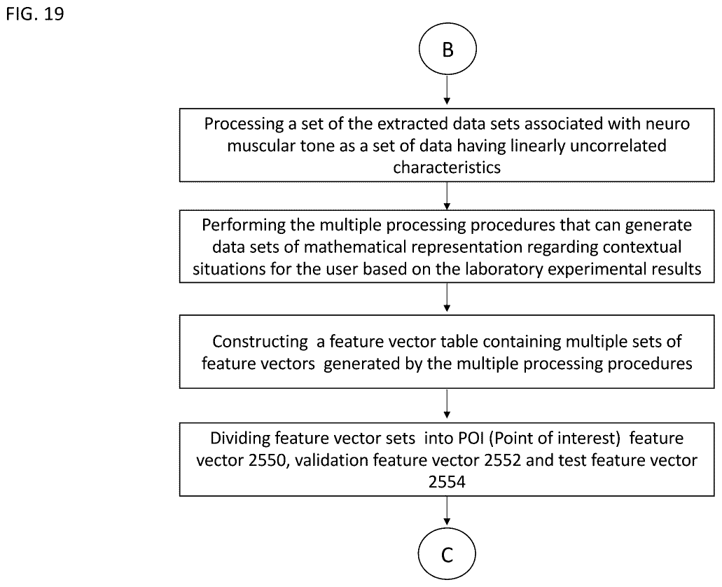

FIG. 19 is an example of a flow chart of feature extracting operation of the Contextual Situations Feature Extractor 804 on the electronic device 500 or the electronic device 401.

In some embodiments, the following values or output data from some processing can be obtained for the preprocessed data and used as feature vectors. In one embodiment, the following values may be obtained for the preprocessed data, and the values may be directly used, partially modified, or some combination of them in order to be used as feature vectors.
Mathematical max, min, median, difference values
Statistical mean, variance, standard variance, energy, entropy
Correlation, zero-crossing rate
DC component, spectral peak, spectral centroid, spectral bands, spectral energy, spectral entropy in frequency domain analysis
Wavelet coefficients of wavelet transformation
Multiple types of features to focus extract physiologically relevant information
Hurst, entropy, Lyapunov divergence with a reduction of sampling for efficiency, Hjorth, Barlow, EEMD . . .
Features above commonly used in ECG and EEG analysis
Combinatorial impact of filters with features

In some embodiments, micro-motion data can be collected from various people and analyzed in the laboratory. By collecting and analyzing data from various sources such as age, gender, region, body physique and etc., we can select features with a low correlation between features.

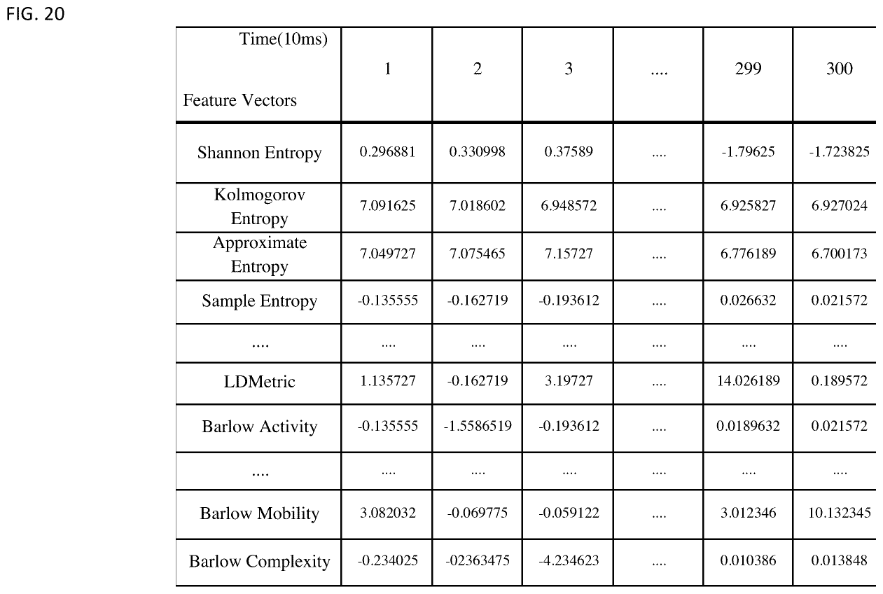

FIG. 20 shows an example of a feature vector set according to some embodiments. The features can also be selected in the laboratory, based on an analysis of the various types of motion classification characteristics shown in FIG. 3. The feature vector set may be configured differently according to the usage of the collected signal. For example, a set of features used for authentication and a set of features for posture estimation or activity information estimation may partially overlap but may be configured differently.

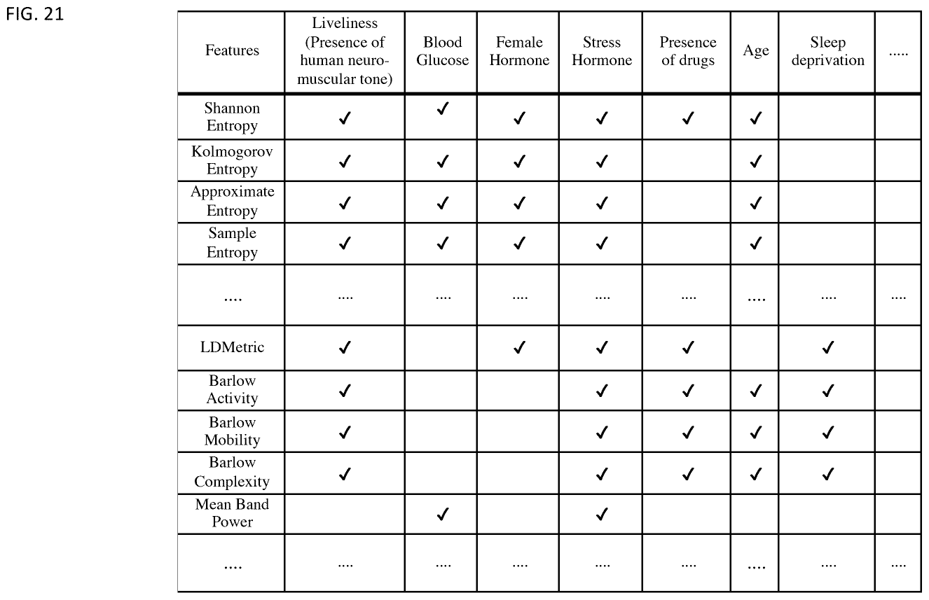

FIG. 21 shows an example of a feature vector set for physiological states according to some embodiments. The features can also be selected in the laboratory, based on an analysis of the various types of experiment results in the laboratory. The feature vector set may be configured differently according to the physiological states. A set of features or weight values of features used for each physiological state may partially overlap or be configured differently.

The above feature vectors in FIG. 21 demonstrate relevant features with checkmarks for the corresponding physiological state according to some embodiments. For Liveliness determination, a feature that contains high information can be Barlow Activity. This feature is able to provide information to a machine learning algorithm on the sum of zero-crossings of a time series accelerometer or gyroscope reading in Static Model Analyzer 806. There are less consistent zero-crossings and zero-crossings of greater magnitude with neuromuscular signals when compared to many mechanically, or non-human, generated signals which affect the value of a feature such as Barlow Activity. This quantitative feature value can contribute information to help make a Liveliness determination by a machine learning classifier.

A separate example of a feature that contains information to help make a classification determination in blood glucose levels can be Mean Band Power. The Mean Band power feature contains information on the power contained in certain frequency bands of the time series signal. This feature may be higher or lower in certain frequency bands based influenced by a user's blood sugar levels. The values of this feature can be used by a machine learning algorithm to determine the presence of low blood glucose or the degree to which the physiological state of low blood glucose is present in Static Model Analyzer 806.

Using a variety of features in combination may be useful when determining the presence of stress hormones or the degree to which stress hormones are present with a machine learning algorithm in Static Model Analyzer 806. More features may be used in the training of the machine learning algorithm to help differentiate the presence of stress hormones in a neuromuscular signal from physiological states where stress hormones may be elevated, such as low blood glucose or sleep deprivation. The information contained in the Mean Band Power feature, LD Metric, Entropy based features, and Barlow Activity and Mobility, can train the machine learning algorithm to recognize the presence of stress hormones more accurately, and provide unique determinations from other physiologic states where stress hormones may also be present, like low blood glucose.

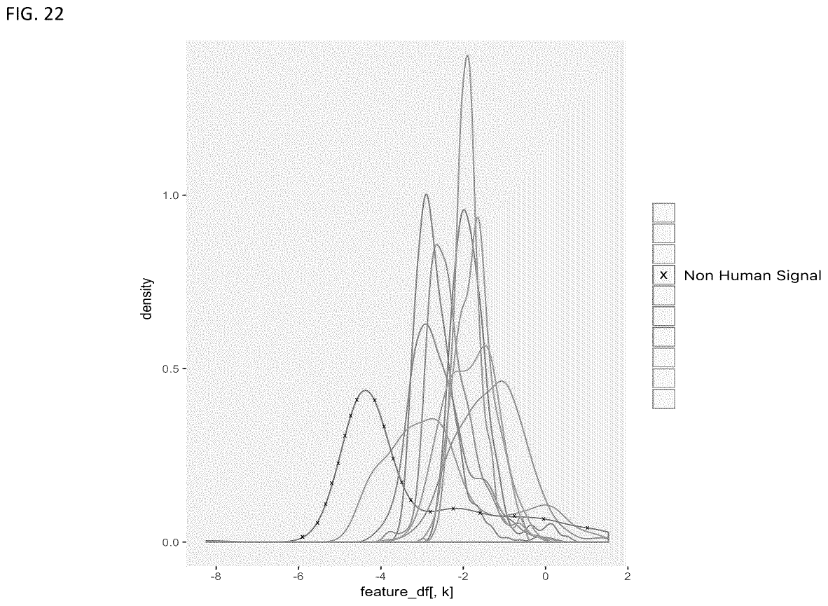

FIG. 22 shows divergence feature distribution that can differentiate humans from non-human as one of the examples in the disclosure. This plot shows the distribution of one feature computed across 9 humans, and the same feature from non-human (static) recordings computed from accelerometer data. The accelerometer data was filtered to frequencies between 10 and 15 hertz which is in the spectrum of human physiological neuro-muscular tone. The distributions show how the value of the feature varies across roughly 100 recordings per person and that non-human signals can be easily distinguished from human signals. This feature can be combined with other features computed from the same signal to further differentiate human signals from non-human signals. The choice or combination of features can vary in the type of physiological states. The features or combination of them that clearly describe physiological states can be determined after appropriate experiments in the laboratory and these experimental results can be directly or indirectly stored on the device as a constraint sets for a static model operation mode. The constraint set can also be downloaded or updated into the device over the network.

In some embodiments, entropy feature analysis can be applied in order to perform static model processing for physiological states of the users including liveliness, blood glucose levels, stress hormone levels, presence of drugs, identifiers, and so on. Entropy is a candidate feature class that is used to predict or measure one or more of the above physiologic states. It is a non-linear feature that is used to quantify the predictability or the information content of a sample of time-series sensor data. Kolmogorov, Approximate, Shannon, and Sample Entropy are all different methods used to quantify the complexity of a time series sample such as accelerometer or gyroscope data. One implementation of an entropy feature used to quantify a physiologic state involves breaking the time series data sample into “N” equal length segments. The computation that is then performed on each segment compares the similarity, or distance, of each segment to all the others based on an experimentally derived distance metric threshold. Each segment receives a score of how many segments it was similar to out of the total number of segments and the average of the logarithm of each proportion is computed. The same calculations are then carried out for segments of increasing length. This entropy value quantifies how repetitive a signal is. Physiological signals, such as neuro-muscular tremor and motion, contain nonlinear, non-repetitive, and complex patterns that express themselves across time. A mechanically created time-series signal, or a signal from a non-biological system, would have a lower entropy value than one influenced by human physiology. Sleep deprivation is known to influence neuro-muscular tremor and the degree to which it does may be quantified using entropy analysis.

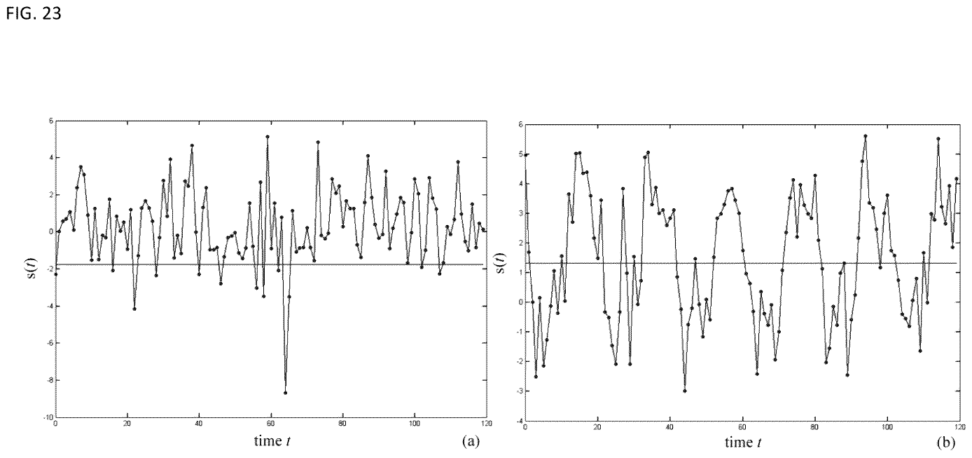

FIG. 23 shows time-series signals of entropy feature analysis. The time-series signal on the left has lower entropy than the time-series signal on the right in FIG. 23. Using such a feature as described, physiologic states can be quantified and represented in an N-dimensional feature subspace used to train a machine learning static model. This static machine learning model can be used to make determination of the presence or absence of any of the above physiologic states and/or the degree or probability that any of the above states are present in a sample of time-series sensor data.

In some embodiments, frequency analysis can be applied in order to perform static model processing for physiological states of the users including liveliness, blood glucose levels, stress hormone levels, presence of drugs, identifiers, and so on. Frequency analysis is a feature class that is used to measure or predict one or more of the above physiological states. One example of a feature that falls within this class is the mean band power feature. The mean band power feature can be used to determine the presence of a physiological state such as low blood sugar. For example, when low blood sugar is present, the amplitude of the signal present may be increased in the accelerometer or gyroscope time series data. This increase in amplitude is likely to present in specific frequency bands related to human physiology and can be measured with the mean band power feature.

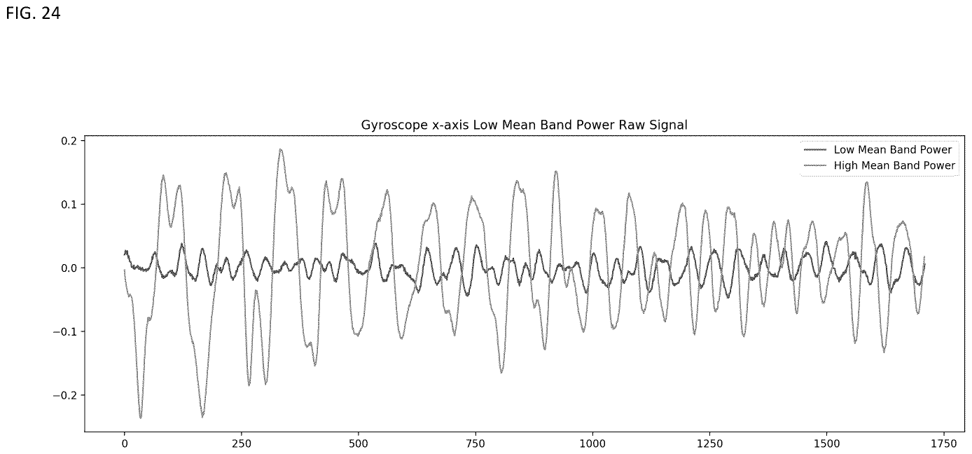

FIG. 24 shows a plot of Gyroscope x-axis Low Mean Band Power Raw Signal. The above figure shows how the orange signal, a signal that may represent a physiological state of low blood sugar, differs from a signal without low blood sugar. The mean band power in specific frequency bands will be higher in the physiological state of low blood sugar.

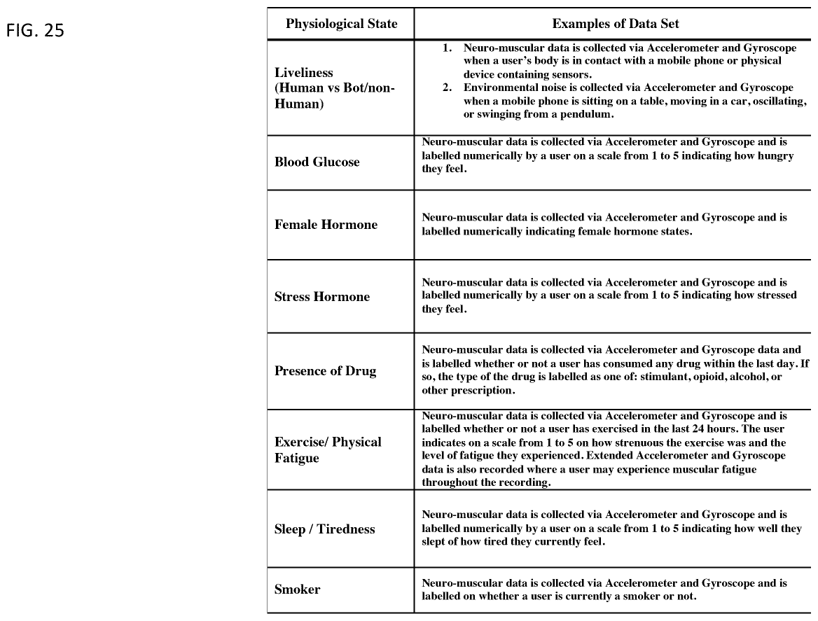

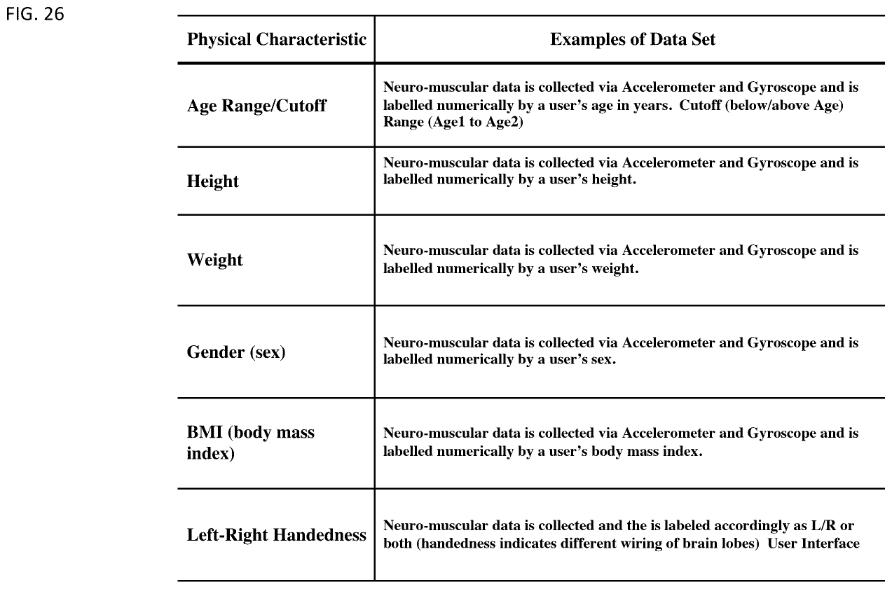

FIG. 25 shows an example of data sets according to physiological states and FIG. 26 shows an example of data sets according to physiological characteristics respectively, that are of interest. The data sets according to physiological states or physiological characteristics can be determined in the laboratory and these sets can be also updated in the electronic device 401, 500 over the network. Prior to starting Static Model processing or when Static model processing starts, the electronic device 401, 500 can configure the Static Model processing system 800 with at least one of the above data sets according to the application.

### (3) The Static Model Analyzer 806

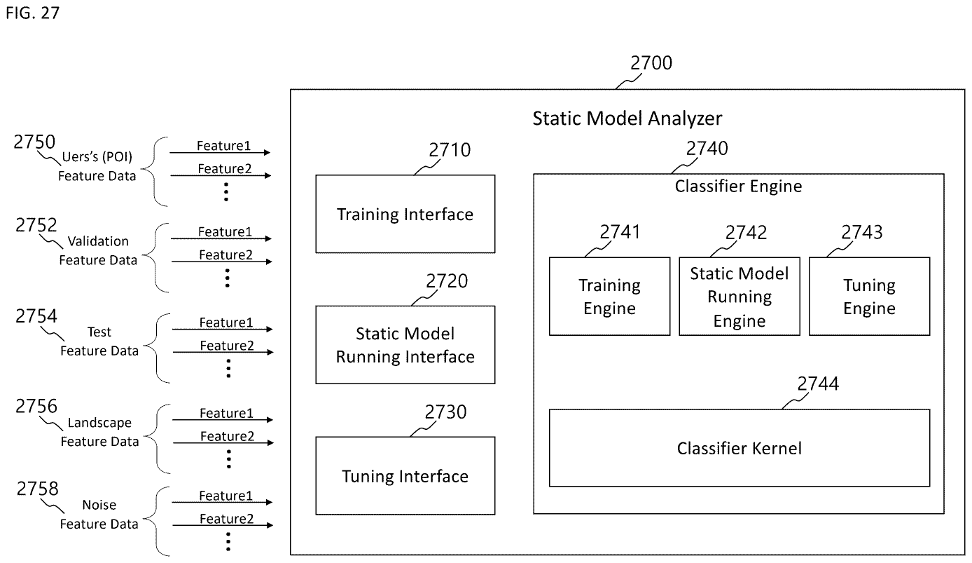

FIG. 27 is a block diagram of the Static Model Analyzer 806, 2700 according to one embodiment. The Static Model Analyzer 806, 2700 can include a Classifier Engine 2740, a Training Interface 2710, a Static Model Running Interface 2720, and a Tuning Interface 2730. The Classifier Engine 2740 can include a Training Engine 2741, a Static Model Running Engine 2742, a Tuning engine 2743, and a Classifier Kernel 2744.

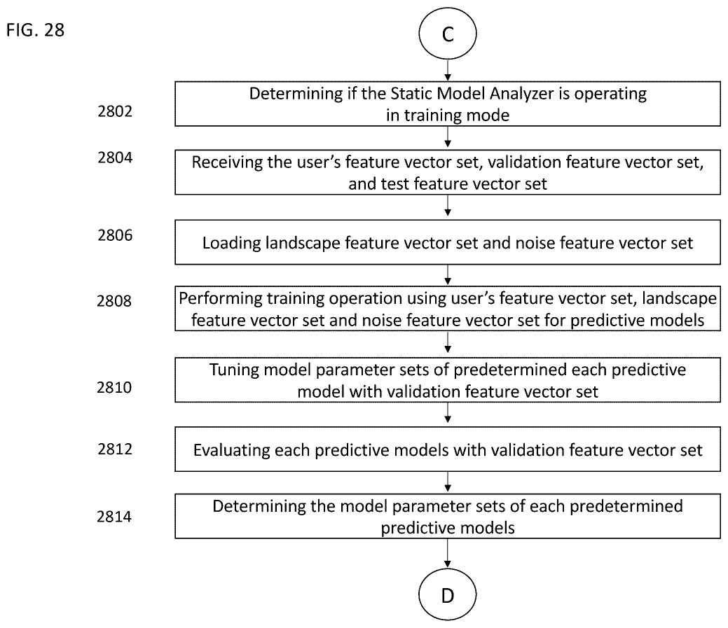

FIG. 28 is an example of a flow chart of training mode operation of the Static Model Analyzer 806, 2700 on the electronic device 401 or the electronic device 500.

The Static Model Analyzers 806, 2700 can be operated in training mode in the laboratory to build static model parameters according to physiological states. The electronic device 401, 500 can enter into this training mode in the laboratory to build some parameters for future use of the static model for physiological states. In some embodiments, building some static model parameters can be performed not on the user devices, but on some laboratory electronic devices as well. In most cases, the electronic device 401, 500 for users doesn't necessarily need to enter into training mode except updating or modifying parameters for the static models. The FIG. 26 or FIG. 27 can be used to build some static model parameters.

When operating in the training mode, the feature data 2750 of the authorized user extracted from the Contextual Situations Feature Extractors 804, 1500 can be collected. The collected feature data can be transferred to the Training Engine 2741 of the Classifier Engine 2740 through the Training Interface 2701 for processing. In this case, the user's feature data 2750 may be processed by various data processing algorithms or machine learning algorithms through cooperative operations of the Training Engine 2741 and the Classifier Kernel 2744 to determine the parameters of the static model.

In order to increase the accuracy or performance of the static model, the extracted feature data can be divided and processed into User's Feature Data 2750, Verification Feature Data 2752 and Test Feature Data 2754. The User's Feature Data 2750 can be used for training to determine the parameters of the static model. The Validation Feature Data 2752 can be used to improve the model's performance or accuracy during training mode prior to evaluating the static model to select an optimal model. For example, the Validation Feature Data 2752 can be used to tune the learning rate or perform validation while evaluating the performance of the model during training mode. The Test Feature Data 2754 can be used to evaluate the final model instead of being used to select the model. The Noise Feature Data 2758 can be a sort of feature data generated through a noise collection process. For example, the Noise Feature Data 2758 can be extracted from a signal collected in an environment in which a large number of components other than micromotion associated with neuro-muscular tones such as the existence of large movements or large vibrations around the electronic device. The Landscape Feature Data 2758 can be a feature data collected from various people and feature extraction performed in a laboratory. Extracted landscape feature data may be stored in the storage of the electronic device in some sets and used to improve the performance of the static model.

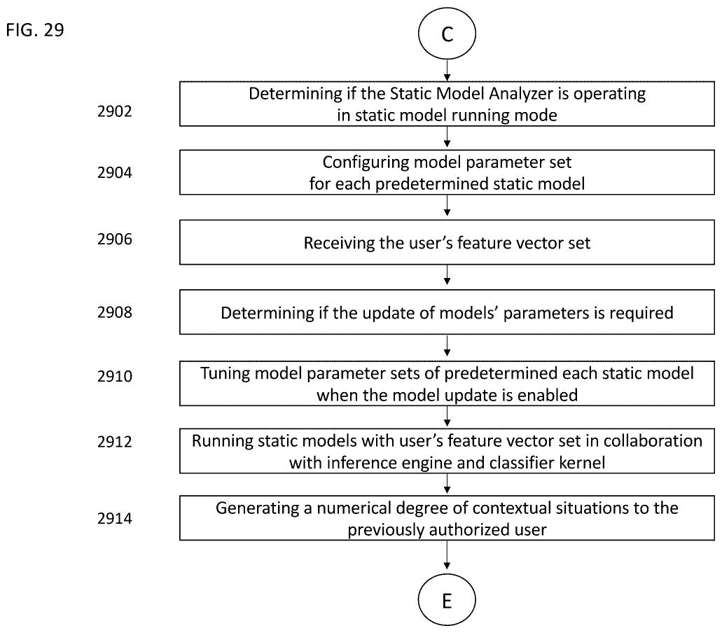

FIG. 29 is an example of a flow chart of static model running mode operation of the Static Model Analyzer 806, 2700 on the electronic device 401 or the electronic device 500.

The Static Model Analyzer 806, 2700 can be operated in a static model ruining mode. The electronic device 401, 500 can have been operated in the training mode before the electronic device 401, 500 operates in the static model running mode so that parameters for the model for the feature data set of the physiological states for the user are already configured. When the information on the static model has already been generated, the Static Model Running Engine 2742 of the Classifier 2740 can be operated in collaboration with the Classifier Kernel 2744 through the Static Model Interface 2720 for the user's new feature data 2750. The Classifier Kernel 2744 based on the previously generated static model can perform an operation on the newly extracted feature data to generate a numerical degree of physiological states to the previously authorized user.

### (4) The Static Model Application Framework 808

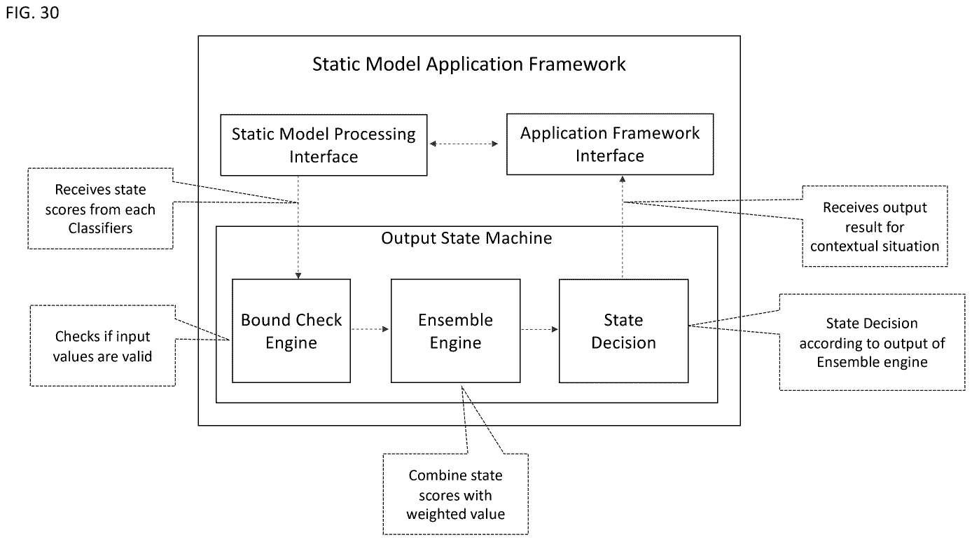

FIG. 30 shows a block diagram of the Static Model Application Framework 808 according to one embodiment. In some embodiments, the Static Model Application Framework 808 can provide to enable various applications using the output of the Static Model Analyzer 806. The Static Model Application Framework 808 can include an output state machine for performing static model processing for contextual situations including physiological states of the users. The Static Model Application Framework 808 can provide application programming interfaces (APIs) regarding physiological states of the users including liveliness, blood glucose levels, stress hormone levels, presence of drugs, identifiers, and so on.

In some embodiments, the Static Model Application Framework 808 can use the user's extracted feature data associated with contextual situations including physiological states of the users. User's feature data can be acquired by the Contextual Situations Feature Extractor 804 and they may be stored in the secure storage of the electronic device. To achieve a higher level of security for the personal biometric information, the Static Model Application Framework 808 can use temporarily feature data associated physiological states of the users and then discard them after using them.

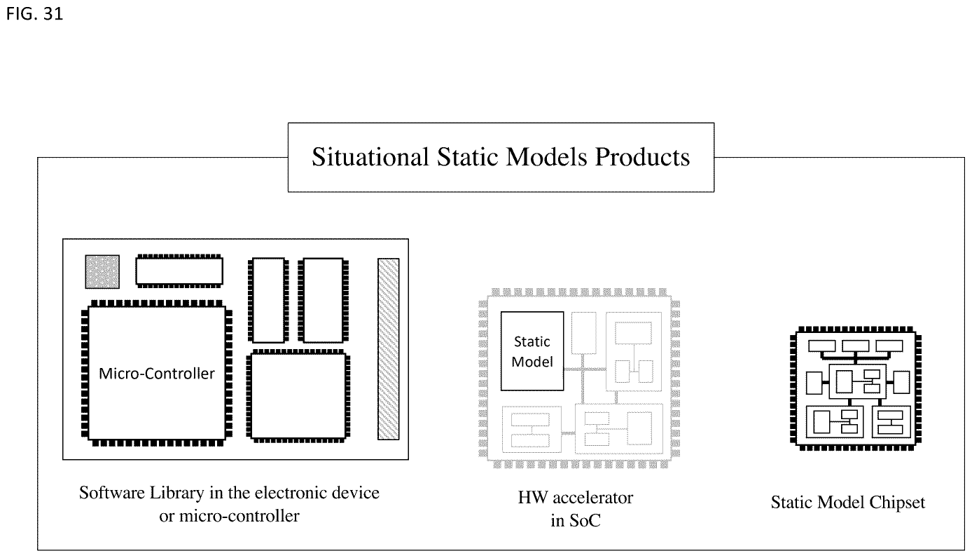

FIG. 31 shows an example of a device type of Situational Static Models. The Static Models may be implemented in hardware, implemented in software, or implemented in a combination of hardware and software. The Static Models may be in the form of a software library that is executed in the microcontroller. Some components of the Static Models may be implemented inside SoC in the form of an accelerator. The Static Models may be fully implemented in the form of the standalone chipset (or ASIC) as in FIG. 31 as well but the implementation form of the Static Models is not limited to present examples.

### Application Example of the Static Model Processing System for Liveliness

Fraudulent access to web-sites and devices is a mounting problem in the cyber world. Hackers, cyber criminals and even nation states are continually prodding the net looking for vulnerabilities to exploit for financial, political and other gains. These criminals gain access to private/confidential accounts by hacking repositories in the Cloud; by utilizing cyber robots, and by using counterfeit logon credentials. The advent of ever more performing AI (Artificial Intelligence) adds an additional threat: what would prevent an all “knowing” AI bot which had access to someone's full digital and authenticating trails to digitally impersonate this very same person. One method of dealing with the robotic and counterfeit attempts to compromise secure locations is to augment logon credential and authentication techniques. One way that authentication efforts can be strengthened is by coupling authentication requests with secondary authentication input, (multifactor authentication), and/or by adding a “liveliness” credential to validate that the authentication request is being made by a live requestor and not by a robot or counterfeit inanimate data. The goal of current “liveliness” determination technologies such as CAPTCHA and others, is to determine whether a human is participating in an online-transactions versus spambots. CAPTCHAs are in common use in the on-line world and are seen frequently in desktop computing, when requesting access to a website. What is proposed is a method to supplement any authentication method with an indicator of “liveliness” verifying that the users employing any of the many authentication methods is a physiologically active, living/breathing individual. The methods described below are giving proof that a live person—and not a bot or an AI—is providing the authentication information. Identification of individuals can be the function of authentication methods. This is important because it means that unlike authentication technologies where the accuracy must be above 95% (and hopefully closer to 100%), the goal of the method to demonstrate liveliness is actually binary: Alive—or NOT alive?

There are many situations where this is of value. This novel approach can use data that can be passively collected from the ubiquitous embedded sensors present in hand-held mobile devices while the user completes a form, or provides another form of authentication, with no additional action necessary on the part of the user.

When requesting access to a website on a mobile device, sensor data from the device can be collected in the background. Contact and interaction with the device, will be evident in accelerometer, gyroscope, and other sensor data streams. One component of the sensor data is associated with the neuro-muscular tone generated by the body's proprioceptive system where the brain is continually communicating with the peripheral nerves to assess the body's position in the environment. Other physiologic biometric parameters can be used as well (i.e., ECG, EEG, HVR, heart sounds, etc.) to provide a liveliness indicator, however, these parameters would require additional hardware to collect those signals. Extracting neuro-muscular data is an invisible process that is easily collected from the accelerometer data being collected by the phone, whenever the user is holding it. This data can be processed remotely or on the device to determine if a human is present. Neural networks, or other methods of machine learning can be used to determine if the signal present is uniquely human. If the result is positive, a user will proceed to submit the form, or gain access to a site, without any additional information. If the result is negative, a traditional CAPTCHA or OTP can be used as a second level authentication request, or the user could be requested to hold the device again.

An alternative implementation uses a combination of the above method with external verification where a user receives a prompt via text or phone call and told to hold their device in hand while sensor data is collected from their device.

### Pros:

Completely novel method has no existing methods of circumvention
Requires no additional effort of the user
Uniquely designed for improved user experience on mobile websites
Anticipates trajectory of machine learning where biometrics may be the only feasible method of determining if a human is present in a digital transaction that won't be vulnerable to hackers.

### Cons:

Unexplored territory
In the desk-top setting, accelerometers would have to added to the mouse or touch pad interface to provide micro-motion data.
Device hardware variations
Additional API's would most likely be required for customers

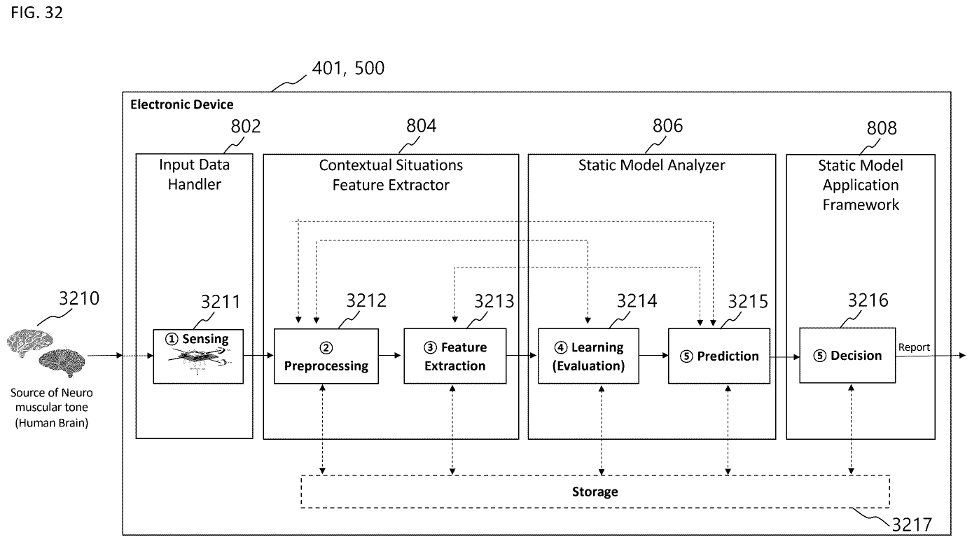

FIG. 32 depicts an example of the static model processing system for liveliness physiological states on the electronic device 401 or the electronic device 500 according to some embodiments. The electronic device can sense signals in Sensing 3211 step from outside of the electronic device by the Input Data Handler 802, for example, a movement signal data from a body part of the user's body. The electronic device can perform preprocessing the signals collected from the Input Data Handler 802 in Preprocessing 3212 step by the Contextual Situations Feature Extractor 804, for example, suppressing signal components associated with a voluntary movement of the user, noise, sensor errors, gravity force, electronic power noise, and other noise-related signal and generating data sets associated with neuro-muscular tone. The electronic device can perform feature extraction from the preprocessed signals in Feature Extraction 3213 step by the Contextual Situations Feature Extractor 804, for example, extract feature vector sets by generating data sets of mathematical representation regarding contextual situations of the user, for example, liveliness state. The electronic device can perform training operations using the feature vector set by calculating parameters of static models and evaluating each static model in Learning 3214 step by the Static Model Analyzer 806. The electronic device can perform Static Model running operations by configuring the model parameter set for each predetermined static model and generating a numerical degree of the matching level to the previously authorized user in Prediction 3215 step by the Static Model Analyzer 806. The electronic device can determine the user access to the electronic device in response to the numerical degree of physiological states in Decision 3216 step by the Static Model Application Framework 808.

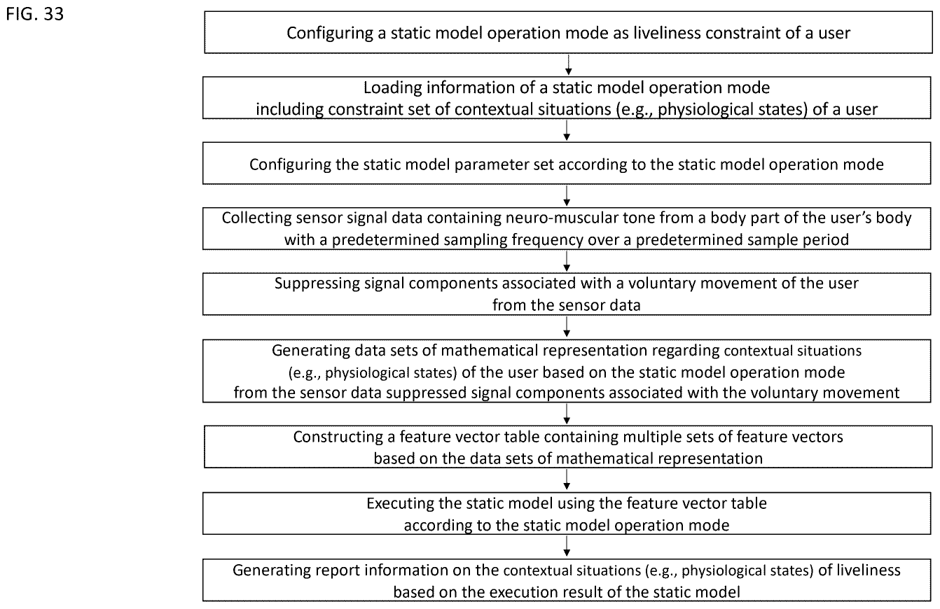

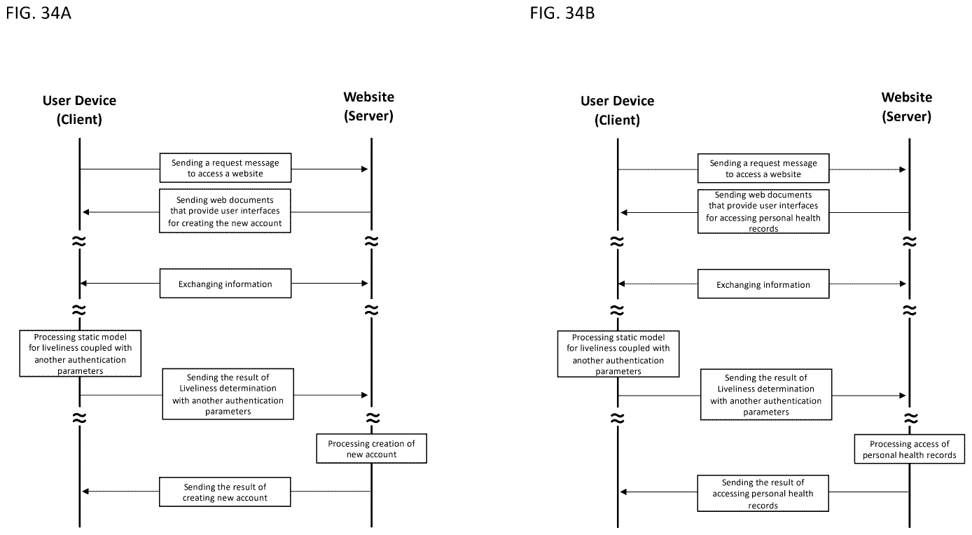

FIG. 33 is an example of a flow chart of static model operation for liveliness on the electronic device 401 or the electronic device 500. The electronic device 401, 500 can configure a static model operation mode as liveliness constraint of a user, load information of a static model operation mode including constraint set of contextual situations (e.g., physiological states) of a user, configure the static model parameter set according to the static model operation mode, collecting sensor signal data containing neuro-muscular tone from a body part of the user's body with a predetermined sampling frequency over a predetermined sample period, suppress signal components associated with a voluntary movement of the user from the sensor data, generate data sets of mathematical representation regarding contextual situations (e.g., physiological states) of the user based on the static model operation mode from the sensor data suppressed signal components associated with the voluntary movement, construct a feature vector table containing multiple sets of feature vectors based on the data sets of mathematical representation, execute the static model using the feature vector table according to the static model operation mode and generate report information on the contextual situations (e.g., physiological states) of liveliness based on the execution result of the static model.

FIG. 34A depicts an example of creating a new account operation using liveliness physiological states. When a user wishes to create the new account on a mobile website or mobile application, the electronic device of the user can send a request message to access the website that provides interfaces of creating the new account, the electronic device on a server-side can send web documents that provide user interfaces for creating the new account based on the request of the electronic device of the user. Based on the user's input through web documents, the electronic device of the user and the electronic device on the server-side can exchange information to proceed with creating account procedures. The user enters the website where they wish to create the account and immediately sensors present on the device begin collecting information in the background [initiated by the website] by processing the static model for liveliness physiological states. While the user fills in the required information to create the account, sensors are collecting information passively with or without the user's knowledge. When the user completes all the fields and submits the information to create an account, a liveliness determination will be made from the passively collected data. This liveliness determination will decide whether human physiological signals are present in the passively collected data. In this use case, the passively collected data comes from accelerometers, gyroscopes, and magnetometers in the user's mobile device. Ballistocardiographs (heartbeats), as well as neuro-muscular tone in the limbs, can be detected from this sensor data. If the signal is determined to contain these physiological signals, the user will be determined to be alive and human and be allowed to create an account on the website or application.

FIG. 34B depicts an example of accessing personal health records using liveliness physiological states. When a user wishes to access a database containing their personal health records, the electronic device of the user can send a request message to access the website that provides interfaces of the database containing personal health records, then the electronic device on a server-side can send web documents that provide user interfaces for accessing personal health records based on the request of electronic device of the user. Based on the user's inputs through web documents, the electronic device of the user and the electronic device on the server-side can exchange information to proceed with login procedures. Upon entering with their established login credentials, a liveliness determination will be performed to ensure a human is performing this action by processing the static model for liveliness physiological states. After submitting their login credentials, but before gaining access to their health records, the user can be requested to use a heart rate sensor on the device they wish to access the health records on. Information collected from this sensor will be computed and a liveliness determination will allow the user to access their health records if the signal collected from the heart rate sensor is determined to contain a human physiological signal.

Any authentication technology—especially image-based methods would benefit from a liveliness verification performed automatically—invisible to the user when the user is attempting to access a website or device. As an example, a user wants to access their online banking web portal and as they open the application and proceed to provide a username and password—or to place their finger on the fingerprint sensor, the phone is simultaneously capturing the neuro-mechanical micro-motion data being collected continuously by the accelerometers in the phone and provides that liveliness verification along with the authentication input.

The static model processing for liveliness physiological states can be coupled with another abstract authentication parameter, i.e., password, PIN number, OTP, etc. or with another behavior-based “liveliness” parameter, i.e., CAPTCHA challenge, motion repertoire, voice commands, swipe patterns, etc. The authentication sample for the static model could be any one of a number of image-based, physical features, or other authentication technologies to include: fingerprints, handprints, iris scans, facial recognition, face veins, etc.

The static model processing can satisfy a liveliness assessment automatically by combining signals representative of any number of physiologic functions, the information received from the user during an authentication request via a conventional modality by sampling physiologic data simultaneously while acquiring an authentication sample using another authentication modality, (i.e., Password/PIN entry, voice commands, facial recognition, handprint analysis, iris scan, behavior repertoire, etc.), by assessing the physiologic data to determine if it is consistent with known physiologic functions, or by then forwarding that determination that a physiologic process is present to satisfy a liveliness assessment to be combined with the authentication sample being collected.

Preventing Under-Age Driving and Vaping with Age Blocking

A neural tapping interface and platforms allow for the capture of signals originating in the nervous system and relayed by the neuromuscular junctions. Those signals are electronic in nature but can readily be captured by their micro-mechanical effects on the muscle cells, using devices that are equipped with micro-electromechanical system (MEMS) sensors. Such device would include smartphones, tablets, but also any system on chip (SOC) system. The signals originating in the nervous system are ubiquitous throughout the human body, and could be acquired nearly anywhere using devices equipped with the appropriate sensors as long as there is a contact between human body and device. Such devices would include vaping systems if equipped with SOC and MEMS.

Given that artificial intelligence (AI) codes can be fully cloudless, it allows a company to build products, which can be trained using very cheap electronic chips (like microcontrollers for example), or to embed fully trained AI codes that could answer/infer some well-defined questions.

Some questions that can be obvious because of their reported effects on the neuromuscular function are age and some neuro-muscular junction influencers like nicotine for ex. It is known that heart rate variability (HRV) (reflecting the autonomous nervous system balance) displays a cut-off at or around 18 years in humans. It is known that the neurotransmission at the neuromuscular junctions relies of nicotinic receptors.

Previously a proof of concept (POC) was formed for an age-blocking (or parental control) application. The AI code for the age-blocking application used smartphones for data capture and inference. The signal processing and data extraction techniques of the implementation (AI code) is not based on classical ‘statistical big data AI’. Such POC, depending on the code versions and implementations, can have an effectiveness (accuracy) between 87-94%. Ninety-four effectiveness (accuracy) percent 94% an age-blocking (or parental control) AI code based on the human nervous system is most likely the absolute limit of the technology, given that there are likely limits to the informational content related to age at the level of the neuro-muscular junctions.

While this age-block application could form the basis of a new class of vaping devices that would markedly decrease under-age vaping and all its potential ill health effects, but also its legal and branding consequences. However, it is preferable to obtain a technology that is more effected and accurate, close to “99%” effectiveness/accuracy. To that end, we can use a fusion of different data types to be more accurate. Individual, non-personally identifiable information (PII) tagging can be used to check the age of a buyer at the Point-of Sale, such as a checkout register, a credit card machine, a wireless contactless payment terminal with near field communication, or other point of sale terminal.

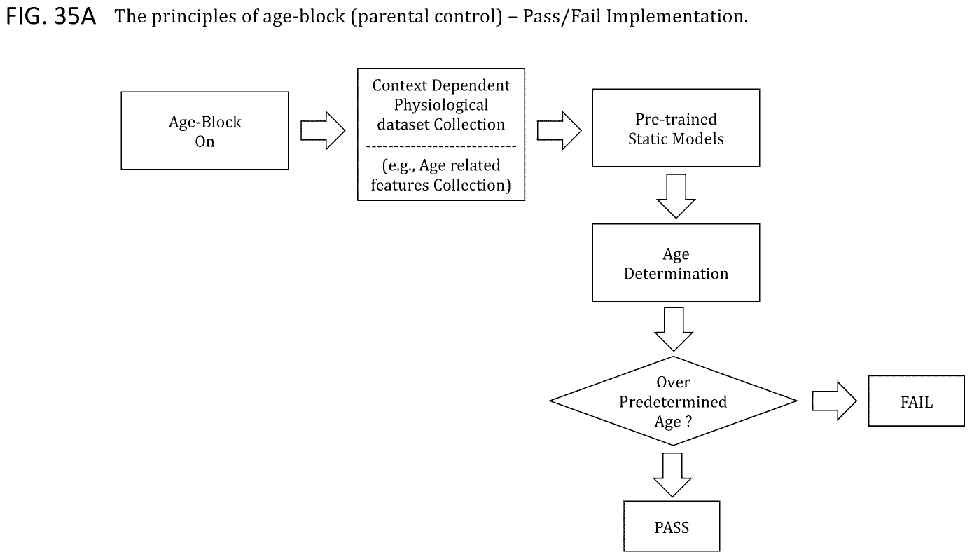

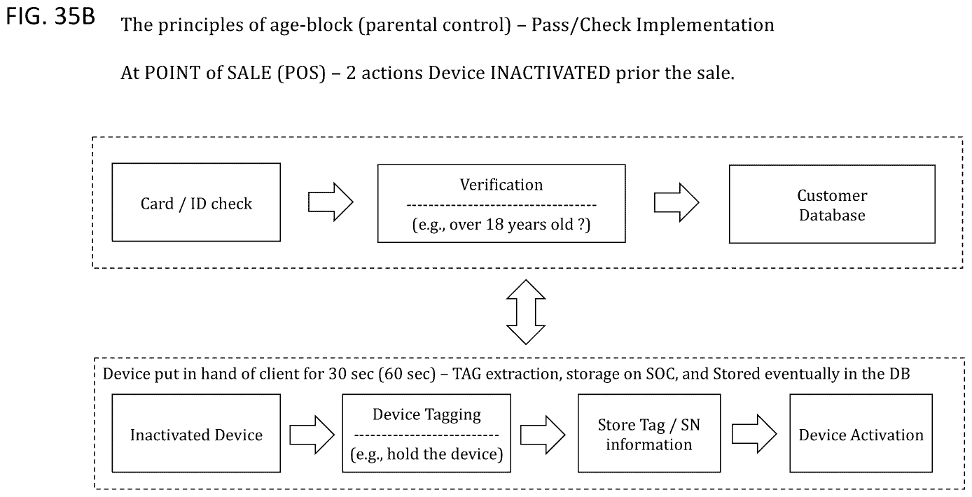

FIG. 35A illustrates a flow chart of using static artificial intelligence models to pass/fail implementation of age-blocking (parental control). If a buyer/user is under age, he is blocked (Fail) from a purchase or sale. If a buyer is of age (greater than equal), the purchase is not blocked (Pass) from a purchase or sale.

A question, for which a physiological marker exists, can be readily addressed by a constrained data set collected from a cohort of volunteers. The constraint can be hormonal status, gender, muscular stiffness, age, etc. This constraint is the condition. Having such data, an AI model can be trained and an inference engine can be built to resolve the condition. Programing code and a framework can be used to deploy pre-trained AI on chipsets such as a microcontroller or a systems on chip (SOC).

In this implementation, the inference results can be used to control an ignition switch in a vaping device on any SW or HW decision point relative to any parental control system based on age-restriction. It is a Pass/Fail model.

A pre-trained AI (context dependent physiological dataset, here context=age) is embedded inside a SOC in a vaping device. SOC is a cheap chipset with the appropriate sensors that allow for data capture, processing for extracting the relevant information (feature functions) and inference. The result of the inference step can be used either in a pass/fail implementation or in a pass/check implementation.

In a pass/fail, the inference results are used to control the ignition switch of said device. The accuracy of the AI could be boosted at some higher level (like 94-95%), and while this is way better than any other parental control that actually exists, it leaves space for some false positives and false negatives.

It was desirable to reach a near perfect solution—able to reach 99% accuracy. As no math, and no AI code can ever reach this on its own, additional AI codes were used to allow for a secondary inference (called a TAG) to be fused together and implemented in the system in a way that makes breaches extremely unlikely with the highest trust possible. This implements a Pass/Check system instead of a Pass/Fail system.

FIG. 35B illustrates a client server implementation of the age blocking and processes in each. The process makes use of 2 checks performed at the point of sale of any device, under the supervision of the accredited salesperson. It is the understood that some form of control is implement according to legal statutes barring the sales of vaping to minor. The cutoff ages may vary between 18, 21, or 26 as the case may be but with the fused data implementation remain the same, but with adapted inference of the model for each different age limit.

This implies that the vaping device (or any other device) is shipped in a locked state (via its firmware, and will have to be un-locked/activated upon the completion of said sale with the age blocking artificial intelligence based on neurological signals.

At point of sale (POS), an age blocking solution based on the nervous system combines manual age verification (carting) with a Tag that is user-specific but cannot lead to the user recognition-maintaining the user's privacy. At no time, is any PII is collected by the device. The links in the database between the identification (ID) of the consumer and the TAG may or may not be made. Such link is not essential to a working solution.

This uses two applications of the technology in conjunction with some actions at the point-of-sale (POS). This allows compliance with the eventual legal (or regulatory) requirements that are specific for each country.

At POS, there are 2 steps
Carting/ID check. Depending on the requirements (18, 21, 26), the ID of the buyer is verified and stored in a vendor database.
Tagging. The specific device (serial #) is fully non-active and needs to be activated after the sale.
The tagging is done at POS under vendor supervision in a 3 steps process
   Step 1—Buyer holds the device in one hand for a period of 30-60 sec).
   Step 2—Following this step, the SOC extracts a TAG (less than one second). (TAG=a 3 numbers vector)
   Step 3—upon TAG completion-device is enabled for function.

A TAG is a downgraded inference that extracts a few appropriately chosen features, such as three features. Such TAG is a 3 number vector plus some other parameters. Those parameters reflect the future user, but—on their own—would not be able to allow to identify said user. This is due a.o. to the standard deviations linked to those features, but also to the nature of those features themselves (that is their physiological and use-specific information content).

But this TAG can perfectly be used as a checking and decision-point mechanism to enhance the global accuracy of the Age-block technology. A TAG makes the device rather very personal, without breaching GDPR.

By the combining use of Age-block with a TAG, control at POS, and adding friction in the case of abuses, a cloudless, friction-free AI implementation age based control of any vaping device (or any device or parental control system) with a very high degree of accuracy can be achieved, thereby alleviating regulatory and branding risks.

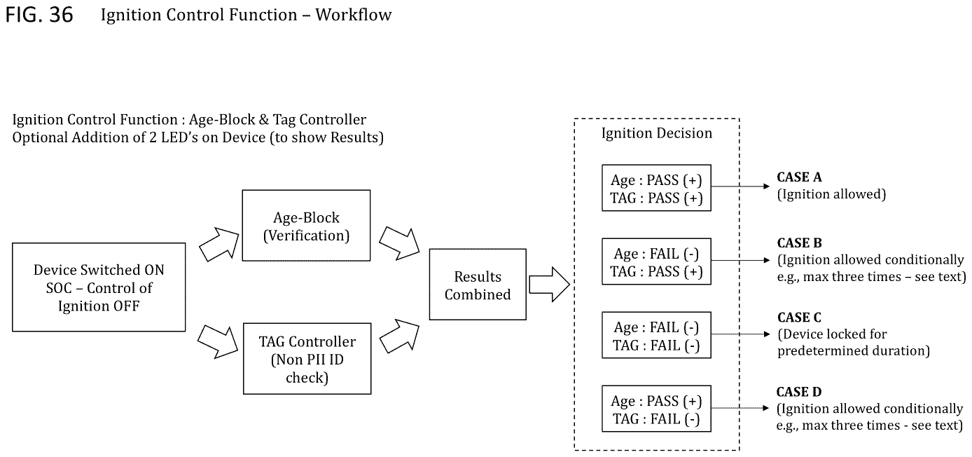

FIG. 36 illustrates another application of an age based application of artificial intelligence based on neurological information. A workflow of an age-controlled ignition control function for a vehicle is shown in FIG. 2. In this manner, children under an age limit would be unable to start the vehicle to operate it.

This solution may be implemented with or without 2 mini LED's that could report the results of the 2 different inferences (red/green). This solution requires that the vendor has a way to interact with the firmware of the device, this is ideally implemented via a connection between device and some other device provided to the POS terminal.

After ID check and carting, the Device Switch is “on”
User holds device in hand
NON-PII Neural Data acquired
AGE block and TAGGING codes activated and results given (2 LED's).
4 situations can be obtained, depending on the separate pass/fail of each engine.

### Four Cases can Occur as Follows:

A. Age (+) Pass-Tag Pass (+)=>Device SOC allows ignition to proceed.
   This would be the case where Age is above the legal limit, and TAG falls within the appropriate parameters.
   Thus, the user is of age and falls within the range of where he/she should be.
B. Age (−) Fail-Tag Pass (+)=>Device SOC allows ignition to proceed but counts
   If this situation repeats [MAX 3× ], then Device SOC locks.
   Go to POS for check-Vendor verifies if age legal and if repeat confirmed (4^{th} time), then AGE stringency lowered. This will take care of false negative cases. That is if a user who is of age, still occasionally fails the age-block. A special adaptation for the user is put into the device firmware by the vendor (via the connection).
C. Age (−) Fail-Tag Fail (−)=>Device SOC locks for x minutes (x=3 min e.g.)
   After x minutes, if repeated result, then Device SOC locks PERMANENTLY.
   It can then only be reactivated at POS with its legitimate owner as per database.
      This will take care of abusive usage, like the device was bought by an adult and given to an underage person for use. Obviously the person is too young, but the device TAG is far away from this person too.
D. Age (+) Pass-Tag Fail (−)=>Device SOC allows ignition to proceed and counts
   If situation repeats itself 3×, then Device SOC locks. This would take care of false positive cases.
   This would also be the case when another adult user (non-buyer) is using the device. It would allow this 3× only (this can be modified according to some commercial needs of course).
   After the max number, one has to Go to POS to unlock.

### Principles:

Personalization of device via TAGGING,
check at POS and
“punitive” friction is used.

Tagging can be effective at 90% (it does not allow for identification, but the max overlap see FIG. 5 is at 7-8%), when combined with Age blocking effective at 90%, the cumulative error rate when both processes are fused and used together the error rate is at or below 1%, such as can be desirable to unlock an ignition of a vehicle.

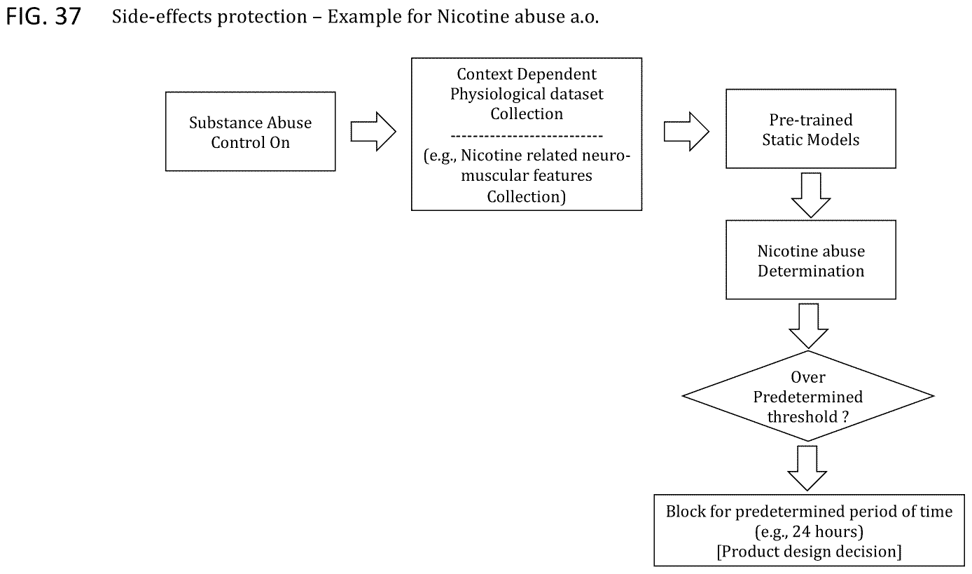

FIG. 37 is a flow chart of providing additional AI to provide side-effects protection from Nicotine abuse.

With the capability of the SOC inside the vaping device, the effects of some drugs/products/medications on the neuromuscular junctions can be monitored for negative side effects.

Nicotine is one obvious choice of drug that can be monitored, possibly positioning and branding vaping technology as a way to help quit smoking. Such effects will of course require a context-specific dataset, that will have to be collected (2,000 users at various nicotine doses), in order to train this additional static AI model aimed at infer nicotine at a few nicotine usage thresholds. This is a safety feature of the vaping technology, that would only allow Ignition at safe levels (or some defined levels of Nicotine). This is Software driven switch.

The device can be equipped with a third static AI model, pre-trained with a neuro-muscular general dose-response curve. The inference can be triggered at regular time intervals during vaping device usage, or can be used as an additional condition for ignition (this would be a product choice).

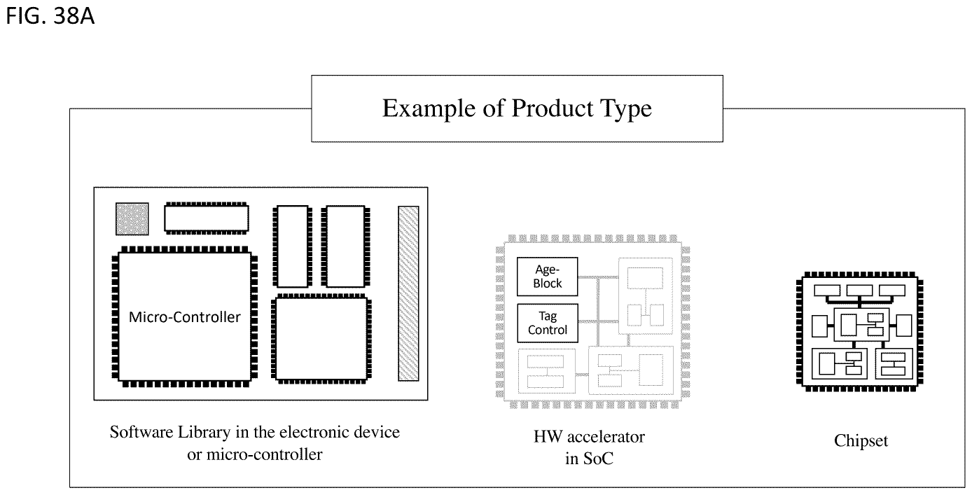

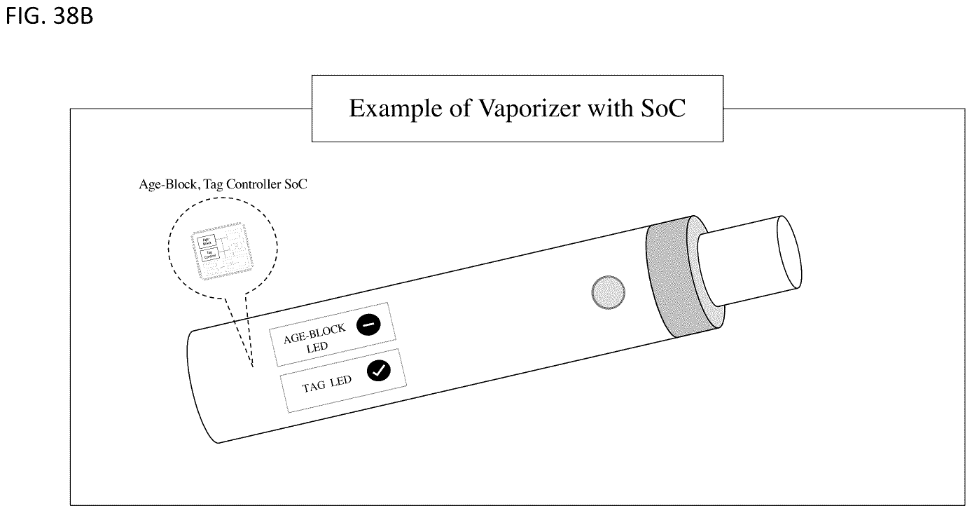

Referring now to FIG. 38A, AI technology based on neurology can be embedded in phones, or any HW/SW SOC device to form a parental control device.

FIG. 38B illustrates a vaporizer with a system on a chip and the artificial intelligence to provide age blocking.

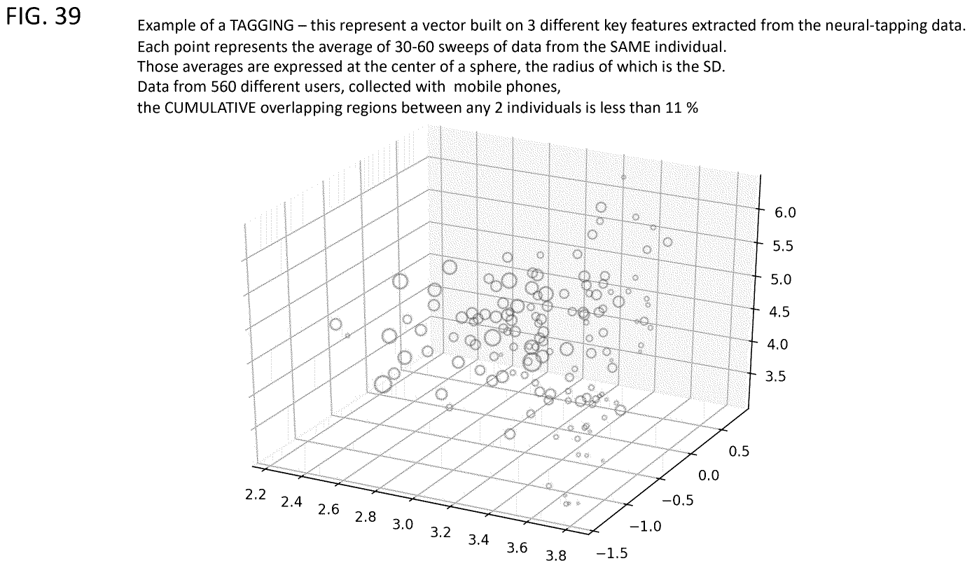

FIG. 39 illustrates a three dimensional plot of bubbles representing fused data one of which is a tag to improve accuracy and decrease error by tagging. Three numbers are combined as vectors into a single bubble plot for a user. Each bubble that is plotted represents a different person, for whom 3 numbers (from 3 different AI functions) were extracted 30-60 times and fused together. The repeated tests were averaged together and represented as points in 3-D space in FIG. 39. The diameter of the circles (bubbles) represent some statistical dispersion (SD and others) of the tests of a user.

The data needed to calculate those repeats is taken at a POS terminal during the period of 30 to 60 sec during which the buyer is asked to hold the device in one hand. The computation time to extract and average is around 20 milli-seconds (msec), then the vector is stored on device memory (or could be exported via connection to a user DB).

FIG. 39 illustrates a 3-D vector space built on 3 different key features extracted from the neural-tagging data. Each point (bubble) represents the average of 30-60 sweeps of data from the same individual. Those averages are expressed at the center of a sphere, the radius of which is the standard deviation (SD). Data from 560 different users (graph not complete, some users out of axis scale ranges) is collected with mobile phones. The cumulative overlapping regions of bubbles between any 2 individuals is less than 11%.

### CONCLUSION

When implemented in software, the elements of the embodiments are essentially the code segments of instructions that can be executed by one or more processors to perform and carry out tasks and provide functionality. The program or code segments can be stored in a processor readable medium or storage device that are coupled to or at least in communication with the one or more processors. The processor readable medium can include any medium or storage device that can store information. Examples of a processor readable medium include, but are not limited to, an electronic circuit, a semiconductor memory device, a read only memory (ROM), a flash memory, an erasable programmable read only memory (EPROM), a floppy diskette, a CD-ROM, an optical disk, a hard disk, or a solid-state drive. The program or code segments can be downloaded or transmitted between storage devices, for example, over computer networks such as the Internet, Intranet, etc.

While this specification includes many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations, separately or in sub-combination. Moreover, although features may be described above as acting in certain combinations and even initially claimed as such, one or more features from a claimed combination can in some cases be excised from the combination, and the claimed combination can be directed to a sub-combination or variations of a sub-combination.

Accordingly, while certain exemplary embodiments have been particularly described and shown in the accompanying drawings, they should not be construed as limited by such embodiments, but rather construed according to the claims that follow below.

1. A method comprising:
generating a plurality of constrained data sets associated with a plurality of predetermined constraints linked to a plurality of predetermined physiological conditions;
building a plurality of independent static models based on the plurality of predetermined physiological conditions, wherein each independent static model is linked to a specific constraint;
installing the plurality of independent static models into an electronic device including a processor to execute instructions and a sensor to collect sensor data linked to the plurality of independent static models;
executing one or more of the plurality of independent static models via a user interface based on the sensor data sensed from the user; and
providing one or more results to the user via the user interface associated with the execution of the one or more of the plurality of independent static models, wherein the one or more results reflects one or more physiological conditions of the user.

2. The method of claim 1, further comprising:
terminating the execution of the one or more of the plurality of independent static models.

3. A method comprising:
generating a constrained data set associated with predetermined constraints linked to a predetermined physiological condition;
building an independent static model based on the predetermined physiological conditions, wherein each independent static model is linked to a specific constraint;
installing the plurality of independent static models into an electronic device including a processor to execute instructions and a sensor to collect sensor data linked to the plurality of independent static models;
executing, by a user, one or more of the plurality of independent static models via a user interface based on the sensor data sensed from the user; and
providing one or more results to the user via the user interface associated with the execution of the one or more of the plurality of independent static models, wherein the one or more results reflects one or more physiological conditions of the user.

4. The method of claim 3, further comprising:
terminating the execution of the one or more of the plurality of independent static models.

5. The method of claim 3, wherein the predetermined physiological condition/state is the age of the user and the constrained data set is associated with a range of age of the user.

6. The method of claim 3, wherein the predetermined physiological characteristic state is the age of the user and the constrained data set is associated with age cutoffs/boundaries conditions of the user.

7. The method of claim 3, wherein the constrained data set is associated with the gender of the user.

8. The method of claim 3, wherein the constrained data set is associated with the attention state of the user.

9. The method of claim 3, wherein the constrained data set is associated with the ovulation status of a female user.

10. The method of claim 3, wherein the constrained data set is associated with the pregnancy status of a female user.

11. The method of claim 3, wherein the constrained data set is associated with the user.

12. The method of claim 3, wherein the constrained data set is associated with right handedness or left handedness of the user.

13. The method of claim 3, wherein the constrained data set is associated with liveliness character of the user to distinguish from a bot or a machine.

14. A method comprising:
forming a plurality of constrained data sets associated with a plurality of predetermined constraints linked to a plurality of predetermined physiological conditions;
forming a plurality of independent static models based on the plurality of constrained data sets and the plurality of predetermined physiological conditions, wherein each independent static model is linked to a specific constraint; and
installing the plurality of independent static models into an electronic device including a processor to execute instructions and a sensor to collect sensor data linked to the plurality of independent static models.

15. The method of claim 14, further comprising:
prior to the installing,
generating a plurality of data sets of mathematical representations from sensor data based on the plurality of predetermined physiological conditions;
performing a training operation using the plurality of data sets for each of the plurality of independent static models; and
determining the model parameter sets of each of the plurality of independent static models.

16. The method of claim 15, further comprising:
collecting sensor data including containing neuro-muscular tone from a body part of a user's body with a predetermined sampling frequency over a predetermined sample period; and
suppressing signal components associated with one or more voluntary movements of the user from the sensor data.

17. The method of claim 15, further comprising
splitting the plurality of data sets into a user's feature vector set, a validation feature vector set, and a test feature vector set based on the mathematical representations of the plurality of data sets; and
evaluating each of the plurality of independent static models using the validation feature vector set to validate each of the plurality of independent static models; and
testing each of the plurality of independent static models using the test feature vector set to determine the accuracy of each of the plurality of independent static models.

18. The method of claim 15, wherein the mathematical representation is a feature and the feature is a Barlow feature.

19. The method of claim 15, further comprising
prior to performing the training,
receiving a landscape feature vector set and a noise feature vector set;
wherein the training is performed using the landscape feature vector set and the noise feature vector set.

20-53. (canceled)

54. The method of claim 1, wherein
the one or more physiological conditions of the user are selected from the set comprising age of the user, gender of the user, ovulation status of the user, pregnancy status of the user, handedness of the user, attention state of the user, and liveliness character of the user.
